(19) United States
(12) Patent Application Publication
(10) Pub. No.: US 2015/0337200 A1
(43) Pub. Date: Nov. 26, 2015

(54) LIQUID CRYSTAL COMPOSITION, LIQUID CRYSTAL DISPLAY ELEMENT, AND LIQUID CRYSTAL DISPLAY

(71) Applicant: DIC Corporation, Itabashi-ku, Tokyo (JP)

(72) Inventors: Joji Kawamura, Kita-adachi-gun (JP); Yoshinori Iwashita, Kita-adachi-gun (JP)

(73) Assignee: DIC CORPORATION, Tokyo (JP)

(21) Appl. No.: 14/436,955

(22) PCT Filed: Oct. 23, 2012
(86) PCT No.: PCT/JP2012/077338

§ 371 Date: Aug. 7, 2015

(51) Int. Cl. C09K 19/30

(52) U.S. Cl. CPC C09K 19/3003; C09K 2019/3004; C09K 2019/3009; C09K 2019/301; C09K 2019/3016

(57) ABSTRACT

A liquid crystal composition having a negative dielectric anisotropy includes: a component (B) which contains a compound represented by the following formula (1) and which is a dielectrically neutral component; and a dielectrically negative component (A) which contains at least two types of compounds selected from the group consisting of compounds represented by the following formulas (2) to (5). R¹ and R⁴ each represent an alkyl group having 1 to 8 carbon atoms, R² and R³ each represent an alkyl group having 1 to 8 carbon atoms or an alkenyl group having 2 to 8 carbon atoms.

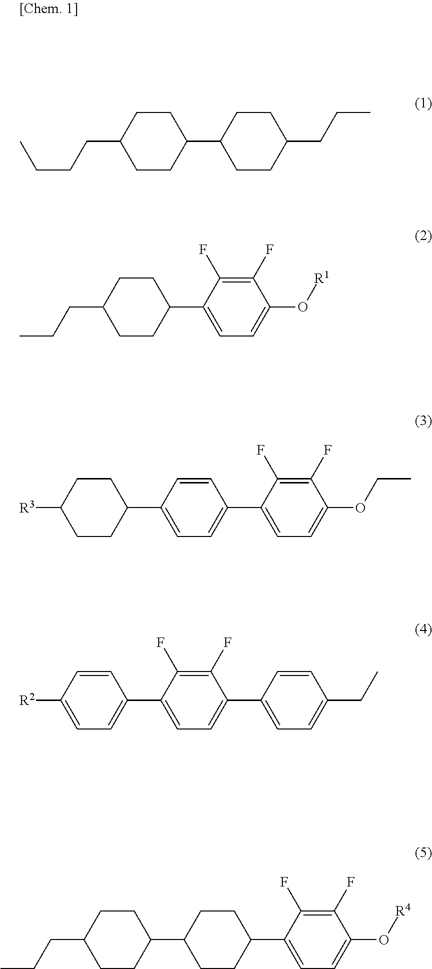

### TECHNICAL FIELD

The present invention relates to a liquid crystal composition, a liquid crystal display element using the liquid crystal composition, and a liquid crystal display.

### BACKGROUND ART

Liquid crystal elements have started to be used not only for a watch and an electronic desktop calculator, but also for various types of measurement devices, an automobile panel, a word processor, an electronic notebook, a printer, a computer, a television, a watch, an advertisement board, and the like. As a representative liquid crystal display type, for example, there may be mentioned a TN (twisted nematic) type, a STN (super twisted nematic) type, a VA (vertical alignment) type, or an IPS (in-plane switching) type, the latter two types each using TFTs (thin film transistors). Liquid crystal compositions used for those liquid crystal display elements are required to be stable against external factors, such as moisture, air, heat, and light, to exhibit a liquid crystal phase in a temperature range as wide as possible around room temperature, and to have a low viscosity and a low drive voltage. Furthermore, in order to obtain optimum values of the dielectric anisotropy (Δ∈), the refractive index anisotropy (Δn), and the like in accordance with respective display elements, the liquid crystal composition is formed from several to several tens of types of compounds.

A liquid crystal composition having a negative Δ∈ is used for a vertical alignment type display, and this type of display is widely used for a liquid crystal television and the like. In addition, all the drive types are required to have a low voltage drive, a high speed response, and a wide operation temperature range. That is, a liquid crystal composition having a positive Δ∈, the absolute value of which is large, a low viscosity (η), and a high nematic phase-isotropic liquid phase transition temperature (Tₙᵢ) is required. In addition, in accordance with Δn×d to be set, which is the product of Δn and a cell gap (d), the Δn of the liquid crystal composition must be controlled in an appropriate range in conformity with the cell gap. Furthermore, when a liquid crystal display element is applied to a television or the like, in particular, since a high speed response is regarded as important, a liquid crystal composition having a low rotational viscosity (γ₁) is demanded.

Heretofore, in order to form a liquid crystal composition having a low γ₁, a compound having a dialkyl bicyclohexane skeleton has been generally used (see PTL 1). However, although a bicyclohexane-based compound has a significant effect of decreasing γ₁, in general, the vapor pressure thereof is high, and this tendency is remarkable in a compound having a short alkyl chain length. In addition, Tₙᵢ also tends to decrease. Accordingly, a compound in which the number of total carbon atoms of side chains is 7 or more is used as an alkyl bicyclohexane-based compound in many cases, and a compound having a short side chain length has not been sufficiently investigated in the past.

Although there has been a composition known as a liquid crystal composition, which uses a dialkyl bicyclohexane-based compound having a short side chain length (see PTL 2), a compound having three ring structures is frequently used as a compound having a negative dielectric anisotropy, and a compound having a difluoroethylene skeleton is used so as to balance the properties of the entire composition. However, the difluoroethylene skeleton used in this composition disadvantageously has a low stability against light, and hence, development of a liquid crystal composition without using the compound as described above has been desired.

In addition, as liquid crystal display elements have been increasingly demanded in various applications, the methods of use and manufacturing thereof have also been dramatically changed, and in order to respond to the changes described above, characteristics other than the fundamental physical properties which have been known are requested to be optimized. That is, as liquid crystal display elements each using a liquid crystal composition, a VA (vertical alignment) type, an IPS (in-plane switching) type, and the like have been widely used, and an ultra-large display element having a size of 50-type model or more has been already developed for practical use and actually used. As the substrate size is increased, a method for injecting a liquid crystal composition to a substrate is changed from a related vacuum injection method to a one drop fill (ODF) method which is now used as a main injection method (see PTL 3), and as a result, the problem in that dropping marks which are formed when a liquid crystal composition is dropped on a substrate degrade the display quality has come up to the surface. In this case, the dropping mark is defined as a phenomenon in which a mark formed by dropping a liquid crystal composition emerges white when black display is performed.

In order to achieve a high speed response to control the pretilt angle of a liquid crystal material in a liquid crystal display element, a PS (polymer stabilized) liquid crystal display element and a PSA (polymer sustained alignment) liquid crystal display element have been developed (see PTL 4), and the problem described above becomes more serious. In general, those display elements are each characterized in that a monomer is added to a liquid crystal composition and is cured therein. In addition, since an active matrix liquid crystal composition is required to maintain a high voltage retention, the use of a compound having an ester bond is restricted, and the number of types of usable compounds is small.

A monomer to be used for a PSA liquid crystal display element is primarily an acrylate compound, and the acrylate compound generally has an ester bond. The acrylate compound is not generally used as an active matrix liquid crystal compound (see PTL 4). When a large amount of the acrylate compound is contained in an active matrix liquid crystal composition, the generation of dropping marks is induced, and degradation in yield of liquid crystal display elements caused by display defects has become a problem. In addition, when additives, such as an antioxidant and a light absorber, are added to the liquid crystal composition, the degradation in yield also becomes a problem.

As a method for suppressing the generation of dropping marks, a method has been disclosed in which a polymer layer is formed in a liquid crystal layer by polymerizing a polymerizable compound which is mixed in a liquid crystal composition, and the number of dropping marks to be generated in relationship with an alignment control film is reduced (PTL 5). However, in the method described above, a burn-in problem of display caused by the polymerizable compound added to the liquid crystal composition occurs, and the effect of suppressing the generation of dropping marks is not sufficient. Accordingly, development of a liquid crystal display element in which while the fundamental characteristics thereof are maintained, a burn-in problem and dropping marks are not likely to be generated has been requested.

### CITATION LIST

### Patent Literature

PTL 1: Japanese Unexamined Patent Application Publication (Translation of PCT Application) No. 2008-505235
PTL 2: Japanese Unexamined Patent Application Publication No. 2012-136623
PTL 3: Japanese Unexamined Patent Application Publication No. 6-235925
PTL 4: Japanese Unexamined Patent Application Publication No. 2002-357830
PTL 5: Japanese Unexamined Patent Application Publication No. 2006-58755

### SUMMARY OF INVENTION

### Technical Problem

The present invention aims to provide a liquid crystal composition which has excellent dielectric anisotropy (Δ∈), viscosity (η), upper limit temperature (Tₙᵢ) of a nematic phase, stability (solubility) thereof at a low temperature, rotational viscosity (γ₁), and burn-in resistance; which is not likely to generate dropping marks during manufacturing of liquid crystal elements; and which can be stably charged in an ODF step. In addition, the present invention also aims to provide a liquid crystal display element using the liquid crystal composition described above and a liquid crystal display.

### Solution to Problem

In order to achieve the above aims, the present inventors carried out intensive research on an optimum configuration of various liquid crystal compositions to form a liquid crystal display element by a dropping method, and it was found that when specific liquid crystal compounds are used at a specific ratio, the generation of dropping marks in a liquid crystal display element can be suppressed, so that the present invention was completed. That is, a first embodiment of the present invention includes the following liquid crystal compositions (i) to (vii).

(i) A liquid crystal composition having a negative dielectric anisotropy, the composition comprising a component (B) which contains a dielectrically neutral compound represented by the following formula (1) and which is a dielectrically neutral component having a dielectric anisotropy of more than −2 to less than +2; and a dielectrically negative component (A) which contains at least two types of compounds selected from the group consisting of compounds represented by the following formulas (2) to (5).

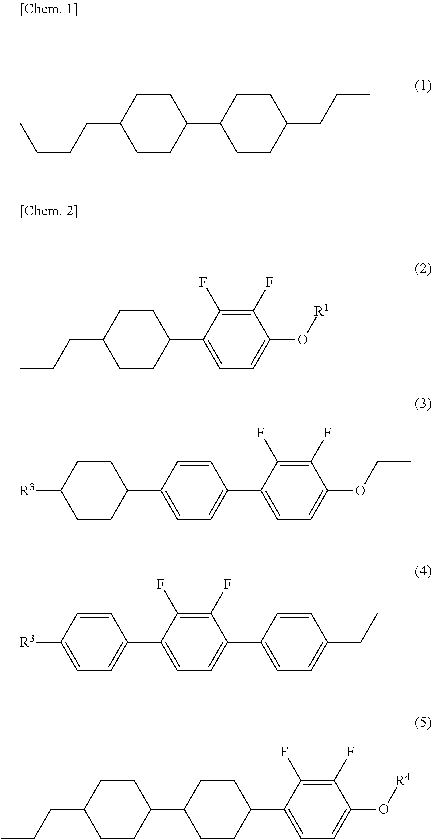

(In the formulas, R¹ and R⁴ each independently represent an alkyl group having 1 to 8 carbon atoms, R² and R³ each independently represent an alkyl group having 1 to 8 carbon atoms or an alkenyl group having 2 to 8 carbon atoms, and at least one methylene group of the alkyl group or the alkenyl group of each of R² and R³ may be substituted by an oxygen atom as long as oxygen atoms are not continuously bonded to each other or by a carbonyl group as long as carbonyl groups are not continuously bonded to each other.)

(ii) The liquid crystal composition described in the above (i) in which the component (A) contains at least two types of compounds selected from the group consisting of compounds represented by the following formulas (2.1), (2.2), (3.1), (3.2), (4.1), (4.2), (5.1), and (5.2).

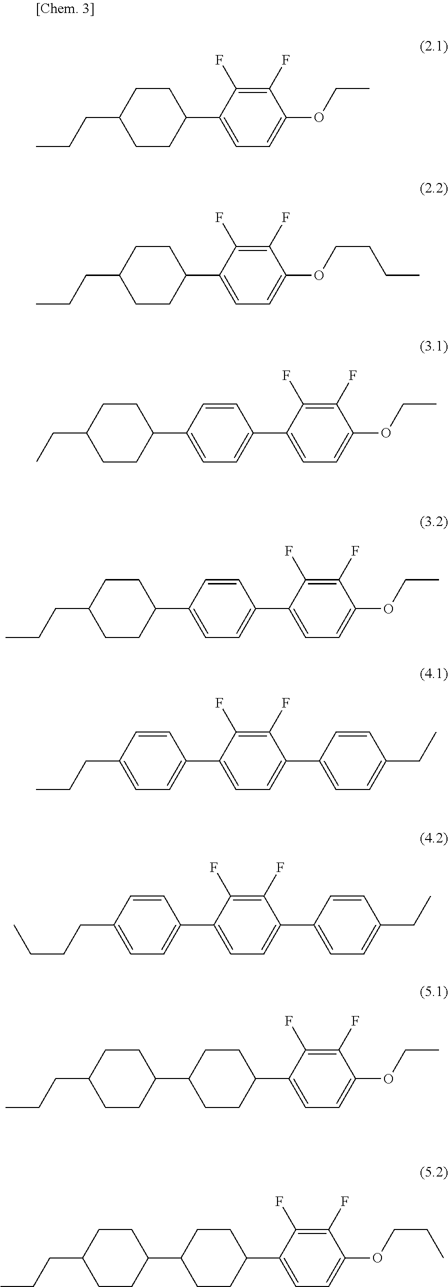

(iii) The liquid crystal composition described in the above (i) or (ii) in which the component (B) contains a compound represented by the following formula (6.1) or (6.2).

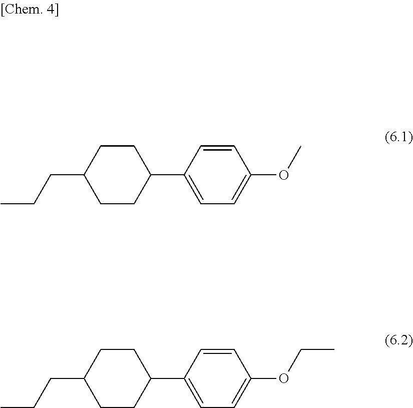

(iv) The liquid crystal composition described in one of the above (i) to (iii) in which the component (A) contains a compound represented by the following formula (7.1) or (7.2).

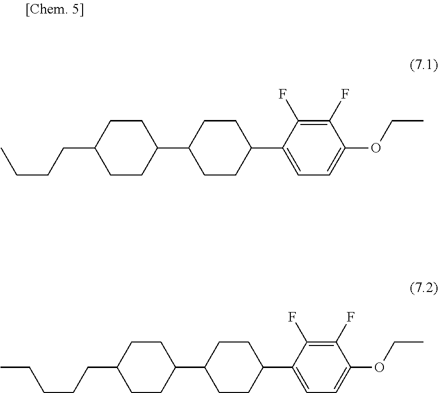

(v) The liquid crystal composition described in one of the above (i) to (iv) in which the component (B) contains a compound represented by the following formula (8).

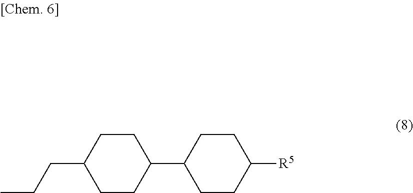

(In the formula, R⁵ represents an alkyl group having 2 or 5 carbon atoms or an alkoxy group having 1 to 3 carbon atoms.)

(vi) The liquid crystal composition described in one of the above (i) to (v) in which the component (A) contains a compound represented by the following formula (9.1) or (9.2).

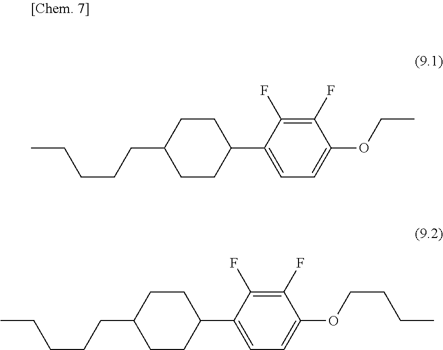

(vii) The liquid crystal composition described in one of the above (i) to (vi) in which the component (A) contains a compound represented by the following formula (10.1) or (10.2).

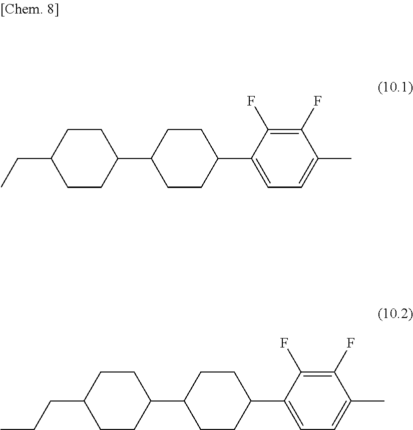

A second embodiment of the present invention relates to a liquid crystal display element using the liquid crystal composition of the first embodiment.

A third embodiment of the present invention relates to a liquid crystal display using the liquid crystal display element of the second embodiment.

### Advantageous Effects of Invention

The liquid crystal composition of the present invention has various excellent properties, such as dielectric anisotropy (Δ∈), viscosity (η), upper limit temperature (Tₙᵢ) of a nematic phase, stability (solubility) thereof at a low temperature, and rotational viscosity (γ₁), and can be stably charged in an ODF step during manufacturing of liquid crystal display elements.

In addition, the liquid crystal display element using the liquid crystal composition of the present invention is excellent in high speed response, is not likely to generate a burn-in problem, and is also not likely to generate dropping marks caused by an ODF step during manufacturing. Hence, the liquid crystal composition of the present invention is effectively used for display elements, such as a liquid crystal television and a monitor.

### BRIEF DESCRIPTION OF DRAWINGS

FIG. 1 is a schematic view showing one example of the structure of a liquid crystal display element according to a second embodiment of the present invention.

FIG. 2 is a cross-sectional view showing one example of the structure of a reverse staggered thin film transistor.

### DESCRIPTION OF EMBODIMENTS

As described above, a detailed process of generating dropping marks has not been clearly understood at this moment. However, it is believed that the generation of dropping marks relates at a high probability to impurities in a liquid crystal compound (liquid crystal composition), an interaction with an alignment film, a chromatographic phenomenon, and the like. The presence or absence of impurities in a liquid crystal compound is strongly influenced by a manufacturing process. In general, in a method for manufacturing a liquid crystal compound, optimum processes and raw materials are investigated for respective compounds. Even when a compound similar to a known compound is manufactured, that is, for example, even when a compound in which the number of side chains is only different from that of a known compound is manufactured, the process therefor cannot be always similar to or the same as that for the known compound. Since a liquid crystal compound is manufactured by a precise manufacturing process, the cost of the compound is higher than those of chemical materials, and hence, the manufacturing efficiency is strongly required to be improved. Accordingly, in order to use a raw material at a cost as low as possible, even if an analogous compound in which the number of side chains is different only by one is manufactured, manufacturing may be more efficiently performed in some cases by using a completely different type of raw material instead of using a known raw material. Hence, a manufacturing process of a liquid crystal substance (liquid crystal composition) may be changed in some cases depending on the substance to be manufactured, and even when the processes are not changed from each other, the raw materials therefor are different from each other in many cases. As a result, impurities contained in respective substances may be different from each other in many cases. In addition, the dropping marks may be probably generated even by a very small amount of impurities, and hence, to suppress the generation of dropping marks only by refining of the substance is limited.

On the other hand, after the manufacturing process is once established, in general, the methods for manufacturing commonly used liquid crystal substances are to be fixed to the respective substances. Although analytical techniques have been advanced at the present, it is still not easy to completely identify the types of impurities which are contained, and hence, the liquid crystal composition is required to be designed assuming that predetermined impurities are contained in the respective substances.

After the relationship between impurities of the liquid crystal substance and the dropping marks was studied by the present inventors, it was experimentally found that impurities contained in the liquid crystal composition are categorized into an impurity which is not likely to generate dropping marks and an impurity which is likely to generate dropping marks. Furthermore, in order to suppress the generation of dropping marks, it was found that the use of a liquid crystal composition containing specific compounds at a specific ratio is important. That is, the liquid crystal composition of the present invention is a composition which is particularly unlikely to generate dropping marks. The following preferable embodiments were found from the points described above.

Hereinafter, although the present invention will be described in detail, the present invention is not limited thereto.

Hereinafter, unless particularly noted otherwise, “%” represents percent by mass.

### <<Liquid Crystal Composition>>

A liquid crystal composition according to a first embodiment of the present invention is a liquid crystal composition having a negative dielectric anisotropy and includes a component (A) and a component (B).

The component (A) is a dielectrically negative component containing at least two types of compounds selected from the group consisting of compounds represented by the following formulas (2) to (5). In addition, the dielectrically negative component is a component having a dielectric anisotropy of “−2 or less”.

The component (B) is a dielectrically neutral component containing a dielectrically neutral compound represented by the following formula (1) and having a dielectric anisotropy of “more than −2 to less than +2”.

The dielectric anisotropy of each component and the dielectric anisotropy of the liquid crystal composition are values measured at 25° C. using a common method.

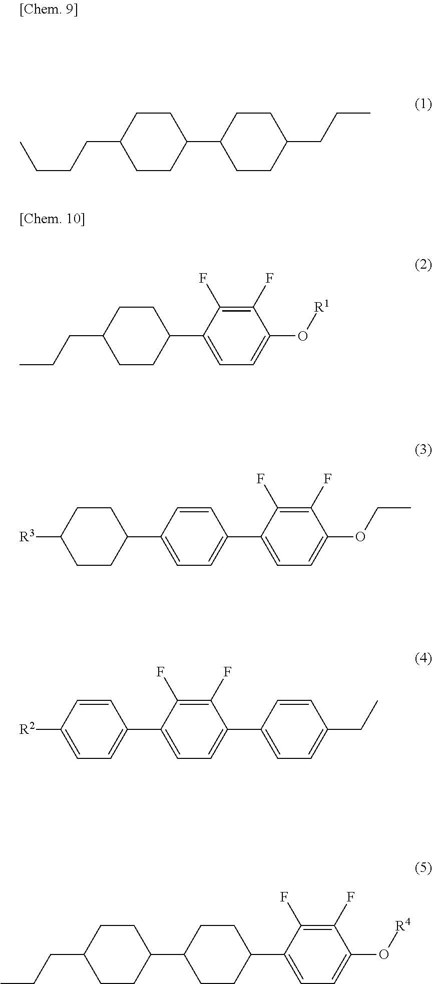

(In the formulas, R¹ and R⁴ each independently represent an alkyl group having 1 to 8 carbon atoms, R² and R³ each independently represent an alkyl group having 1 to 8 carbon atoms or an alkenyl group having 2 to 8 carbon atoms, and at least one methylene group of the alkyl group or the alkenyl group of each of R² and R³ may be substituted by an oxygen atom as long as oxygen atoms are not continuously bonded to each other or by a carbonyl group as long as carbonyl groups are not continuously bonded to each other.)

### <<Component (A)>>

Although the alkyl group of R¹ of the above formula (2) may be a linear chain or a branched chain, a linear chain is preferable. Although the number of carbon atoms of the alkyl group of R¹ is not particularly limited as long as the number is 1 to 8, the number is preferably 1 to 6, more preferably 2 to 5, and further preferably 2 or 4.

Although the alkyl group of R³ of the above formula (3) may be a linear chain or a branched chain, a linear chain is preferable. Although the number of carbon atoms of the alkyl group of R³ is not particularly limited as long as the number is 1 to 8, the number is preferably 2 to 6, more preferably 2 to 4, and further preferably 2 or 3.

Although the alkyl group of R² of the above formula (4) may be a linear chain or a branched chain, a linear chain is preferable. Although the number of carbon atoms of the alkyl group of R² is not particularly limited as long as the number is 1 to 8, the number is preferably 2 to 6, more preferably 2 to 4, and further preferably 3 or 4.

Although the alkyl group of R⁴ of the above formula (5) may be a linear chain or a branched chain, a linear chain is preferable. Although the number of carbon atoms of the alkyl group of each of R¹ and R⁴ is not particularly limited as long as the number is 1 to 8, the number is preferably 1 to 6, more preferably 2 to 5, and further preferably 2 or 3.

The component (A) of the liquid crystal composition described above preferably contains at least two types of compounds selected from the group consisting of compounds represented by the following general formulas (2.1), (2.2), (3.1), (3.2), (4.1), (4.2), (5.1), and (5.2).

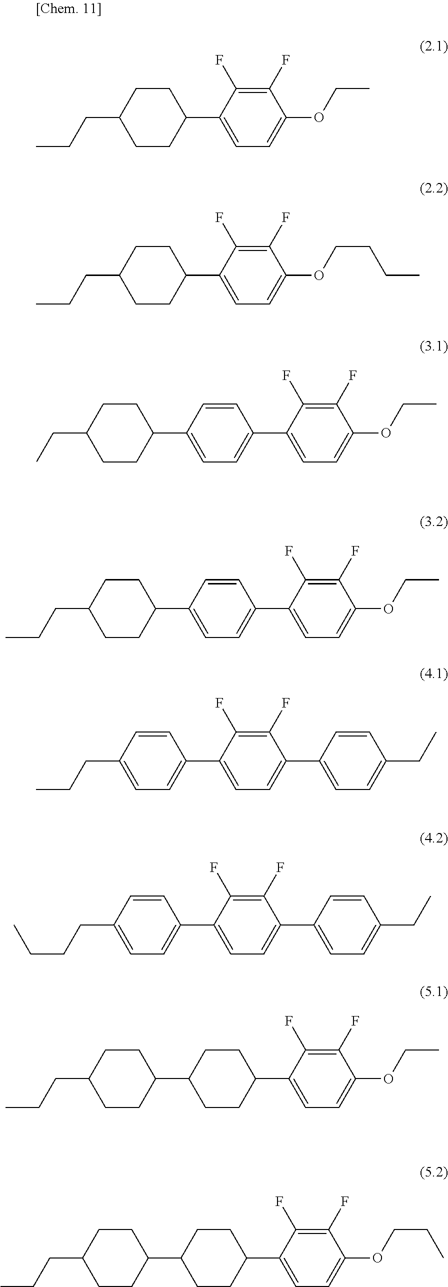

In the case in which the compound represented by the formula (2.1) is contained, the content thereof in the liquid crystal composition is preferably 1% to 20%, more preferably 3% to 18%, and further preferably 6% to 16%.

In the case in which the compound represented by the formula (2.2) is contained, the content thereof in the liquid crystal composition is preferably 1% to 30%, more preferably 3% to 25%, and further preferably 6% to 21%.

In the case in which the compound represented by the formula (3.1) is contained, the content thereof in the liquid crystal composition is preferably 1% to 30%, more preferably 3% to 25%, and further preferably 6% to 20%.

In the case in which the compound represented by the formula (3.2) is contained, the content thereof in the liquid crystal composition is preferably 1% to 20%, more preferably 3% to 16%, and further preferably 6% to 12%.

In the case in which the compound represented by the formula (4.1) is contained, the content thereof in the liquid crystal composition is preferably 1% to 20%, more preferably 3% to 16%, and further preferably 6% to 14%.

In the case in which the compound represented by the formula (4.2) is contained, the content thereof in the liquid crystal composition is preferably 1% to 20%, more preferably 3% to 15%, and further preferably 6% to 13%.

In the case in which the compound represented by the formula (5.1) is contained, the content thereof in the liquid crystal composition is preferably 1% to 20%, more preferably 3% to 16%, and further preferably 6% to 12%.

In the case in which the compound represented by the formula (5.2) is contained, the content thereof in the liquid crystal composition is preferably 1% to 20%, more preferably 3% to 18%, and further preferably 7% to 15%.

The component (A) may additionally contain a compound represented by the following formula (a1).

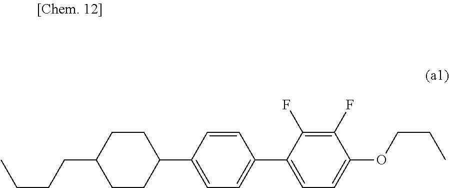 [SMILES: CCCCC1CCC(c2ccc(-c3ccc(OCCC)c(F)c3F)cc2)CC1]

In the case in which the compound represented by the formula (a1) is contained, the content thereof in the liquid crystal composition is preferably 1% to 20%, more preferably 3% to 15%, and further preferably 6% to 10%.

The component (A) may additionally contain a compound represented by the following formula (a2).

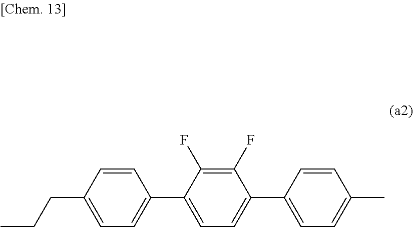 [SMILES: CCCc1ccc(-c2ccc(-c3ccc(C)cc3)c(F)c2F)cc1]

In the case in which the compound represented by the formula (a2) is contained, the content thereof in the liquid crystal composition is preferably 1% to 20%, more preferably 3% to 15%, and further preferably 5% to 10%.

The component (A) may additionally contain a compound represented by the following formula (a3).

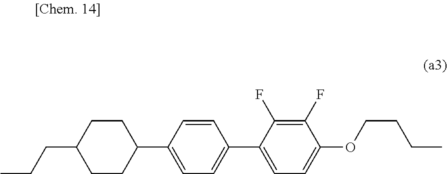 [SMILES: CCCCOc1ccc(-c2ccc(C3CCC(CCC)CC3)cc2)c(F)c1F]

In the case in which the compound represented by the formula (a3) is contained, the content thereof in the liquid crystal composition is preferably 1% to 20%, more preferably 3% to 15%, and further preferably 4% to 9%.

The component (A) may additionally contain at least one of compounds represented by the following formulas (7.1) and (7.2).

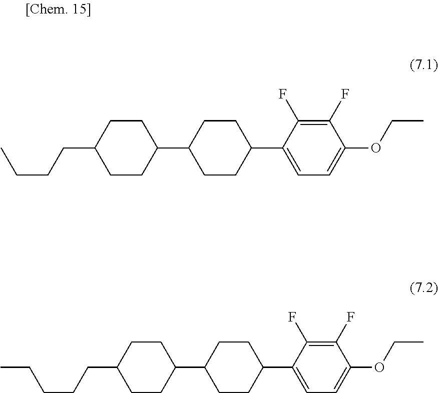

In the case in which the compound represented by the formula (7.1) is contained, the content thereof in the liquid crystal composition is preferably 1% to 20%, more preferably 2% to 15%, and further preferably 3% to 12%.

In the case in which the compound represented by the formula (7.2) is contained, the content thereof in the liquid crystal composition is preferably 1% to 20%, more preferably 5% to 18%, and further preferably 10% to 15%.

The component (A) of the liquid crystal composition may additionally contain at least one of compounds represented by the following formulas (9.1) and (9.2).

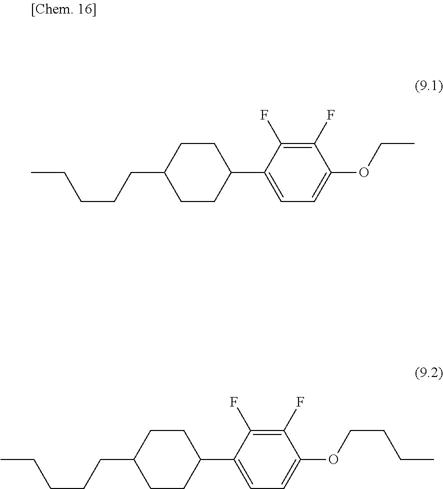

In the case in which the compound represented by the formula (9.1) is contained, the content thereof in the liquid crystal composition is preferably 1% to 20%, more preferably 4% to 15%, and further preferably 7% to 15%.

In the case in which the compound represented by the formula (9.2) is contained, the content thereof in the liquid crystal composition is preferably 1% to 20%, more preferably 5% to 18%, and further preferably 10% to 15%.

The compound represented by the formula (9.1) and the compound represented by the formula (9.2) are preferably contained in the liquid crystal composition together with the compound represented by the formula (2.1) or the compound represented by the formula (2.2).

The component (A) of the liquid crystal composition may additionally contain at least one of compounds represented by the following formulas (10.1) and (10.2).

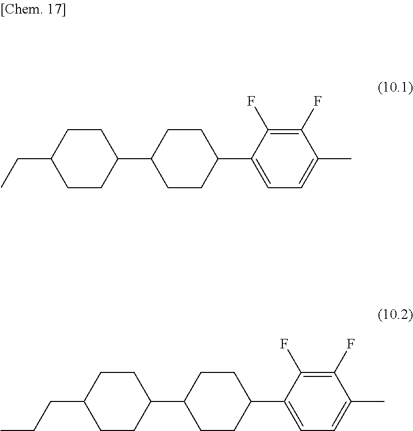

In the case in which the compound represented by the formula (10.1) is contained, the content thereof in the liquid crystal composition is preferably 1% to 20%, more preferably 4% to 15%, and further preferably 7% to 14%.

In the case in which the compound represented by the formula (10.2) is contained, the content thereof in the liquid crystal composition is preferably 1% to 20%, more preferably 3% to 18%, and further preferably 6% to 16%.

The compound represented by the formula (10.1) and the compound represented by the formula (10.2) are preferably contained in the liquid crystal composition together with the compound represented by the formula (5.1) or the compound represented by the formula (5.2).

In the case in which the liquid crystal composition contains the compound represented by the formula (10.1) and the compound represented by the formula (10.2), the total content thereof in the liquid crystal composition is preferably 5% to 35%, more preferably 10% to 30%, and further preferably 15% to 25%.

The component (A) may additionally contain a compound represented by the following formula (a4).

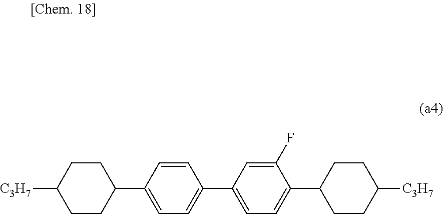

In the case in which the compound represented by the formula (a4) is contained, the content thereof in the liquid crystal composition is preferably 1% to 10%, more preferably 1% to 6%, and further preferably 1% to 4%.

In the case in which the liquid crystal composition contains the compound represented by the formula (1); at least one type of compound selected from the group consisting of the compounds represented by the formulas (2), (9.1) and (9.2); and

at least one type of compound selected from the group consisting of the compounds represented by the formulas (5), (7.1), (7.2), (10.1), and (10.2),
the total content of those compounds is preferably 25% to 90%, more preferably 35% to 90%, further preferably 35% to 75%, particularly preferably 35% to 65%, and most preferably 38% to 60%.

In the case in which the liquid crystal composition contains the compound represented by the formula (1); at least one type of compound selected from the group consisting of the compounds represented by the formulas (2), (9.1) and (9.2); and

at least one type of compound selected from the group consisting of the compounds represented by the formulas (3), (a1), and (a3),
the total content of those compounds is preferably 25% to 80%, more preferably 30% to 75%, further preferably 35% to 70%, particularly preferably 40% to 65%, and most preferably 40% to 60%.

In the case in which the liquid crystal composition contains the compound represented by the formula (1); at least one type of compound selected from the group consisting of the compounds represented by the formulas (2), (9.1) and (9.2); and

at least one type of compound selected from the group consisting of the compounds represented by the formulas (4) and (a2),
the total content of those compounds is preferably 20% to 70%, more preferably 25% to 65%, further preferably 25% to 60%, particularly preferably 25% to 55%, and most preferably 30% to 50%.

In the case in which the liquid crystal composition contains the compound represented by the formula (1); at least one type of compound selected from the group consisting of the compounds represented by the formulas (2), (9.1) and (9.2);

at least one type of compound selected from the group consisting of the compounds represented by the formulas (5), (7.1), (7.2), (10.1) and (10.2); and
at least one type of compound selected from the group consisting of the compounds represented by the formulas (3), (a1), and (a3),
the total content of those compounds is preferably 40% to 90%, more preferably 50% to 90%, further preferably 55% to 90%, particularly preferably 60% to 90%, and most preferably 65% to 87%.

In the case in which the liquid crystal composition contains the compound represented by the formula (1); at least one type of compound selected from the group consisting of the compounds represented by the formulas (2), (9.1) and (9.2);

at least one type of compound selected from the group consisting of the compounds represented by the formulas (5), (7.1), (7.2), (10.1) and (10.2); and
at least one type of compound selected from the group consisting of the compounds represented by the formulas (4) and (a2),
the total content of those compounds is preferably 35% to 90%, more preferably 35% to 85%, further preferably 35% to 80%, particularly preferably 35% to 75%, and most preferably 40% to 70%.

In the case in which the liquid crystal composition contains the compound represented by the formula (1); at least one type of compound selected from the group consisting of the compounds represented by the formulas (2), (9.1) and (9.2);

at least one type of compound selected from the group consisting of the compounds represented by the formulas (3), (a1), and (a3); and
at least one type of compound selected from the group consisting of the compounds represented by the formulas (4) and (a2),
the total content of those compounds is preferably 30% to 90%, more preferably 30% to 80%, further preferably 35% to 75%, particularly preferably 40% to 70%, and most preferably 45% to 65%.

In the case in which the liquid crystal composition contains the compound represented by the formula (1); at least one type of compound selected from the group consisting of the compounds represented by the formulas (2), (9.1) and (9.2);

at least one type of compound selected from the group consisting of the compounds represented by the formulas (3), (a1), and (a3);
at least one type of compound selected from the group consisting of the compounds represented by the formulas (5), (7.1), (7.2), (10.1) and (10.2); and
at least one type of compound selected from the group consisting of the compounds represented by the formulas (4) and (a2),
the total content of those compounds is preferably 60% to 98%, more preferably 65% to 95%, further preferably 70% to 90%, particularly preferably 70% to 87%, and most preferably 70% to 84%.

In the liquid crystal composition, the rate of the compound having at least two fluorine atoms, in particular, the compounds represented by the formulas (2), (3), (4), (5), (a1), (a2), (a3), (7.1), (7.2), (9.1), (9.2), (10.1), (10.2), and (c1), may be 100%, preferably 60% to 98%, more preferably 65% to 95%, further preferably 70% to 90%, particularly preferably 70% to 87%, and most preferably 70% to 84%.

### <<Component (B)>>

Although the component (B) of the liquid crystal composition may contain only the compound represented by the formula (1), the component (B) preferably additionally contains at least one type of compound selected from compounds represented by the following formulas (6.1) to (6.3).

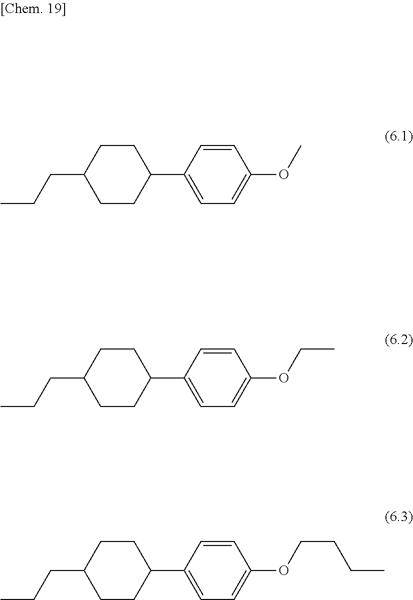

In the case in which the compound represented by the formula (6.1) is contained, the content thereof in the liquid crystal composition is preferably 1% to 20%, more preferably 3% to 15%, and further preferably 6% to 10%.

In the case in which the compound represented by the formula (6.2) is contained, the content thereof in the liquid crystal composition is preferably 1% to 20%, more preferably 3% to 15%, and further preferably 6% to 10%.

In the case in which the compound represented by the formula (6.3) is contained, the content thereof in the liquid crystal composition is preferably 1% to 20%, more preferably 3% to 16%, and further preferably 6% to 10%.

The component (B) preferably additionally contains at least one type of compound selected from the group consisting of compounds represented by the following formula (8).

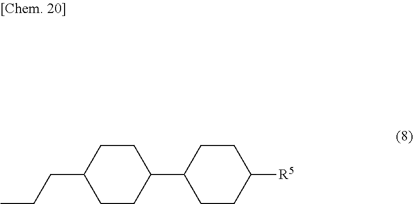

(In the formula, R⁵ represents an alkyl group having 2 or 5 carbon atoms or an alkoxy group having 1 to 3 carbon atoms.)

In particular, the compounds represented by the general formula (8) are compounds represented by the following formulas (8.1) to (8.5).

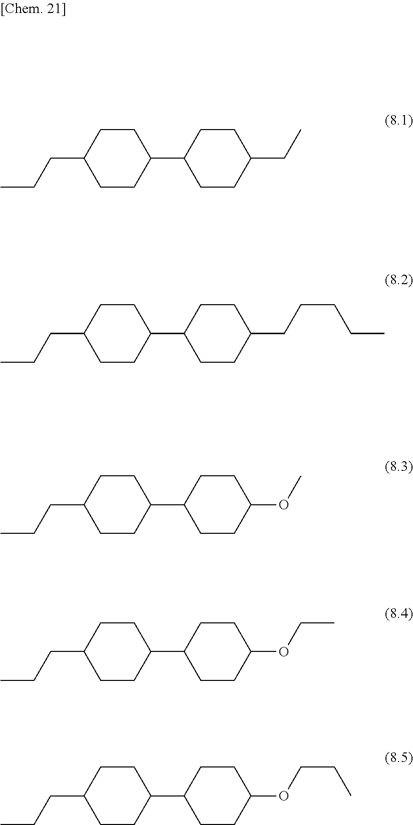

In the case in which the compound represented by the formula (8.1) is contained, the content thereof in the liquid crystal composition is preferably 1% to 35%, more preferably 5% to 30%, and further preferably 10% to 25%.

In the case in which the compound represented by the formula (8.2) is contained, the content thereof in the liquid crystal composition is preferably 1% to 20%, more preferably 3% to 15%, and further preferably 5% to 10%.

In the case in which the compound represented by the formula (8.3) is contained, the content thereof in the liquid crystal composition is preferably 1% to 20%, more preferably 1% to 10%, and further preferably 2% to 8%.

In the case in which the compound represented by the formula (8.4) is contained, the content thereof in the liquid crystal composition is preferably 1% to 20%, more preferably 1% to 10%, and further preferably 2% to 8%.

In the case in which the compound represented by the formula (8.5) is contained, the content thereof in the liquid crystal composition is preferably 1% to 20%, more preferably 2% to 15%, and further preferably 4% to 10%.

The component (B) may additionally contain a compound represented by the following formula (b1).

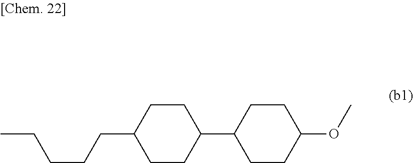 [SMILES: CCCCCC1CCC(C2CCC(OC)CC2)CC1]

In the case in which the compound represented by the formula (b1) is contained, the content thereof in the liquid crystal composition is preferably 1% to 30%, more preferably 3% to 26%, and further preferably 5% to 22%.

The component (B) may additionally contain a compound represented by the following formula (b2).

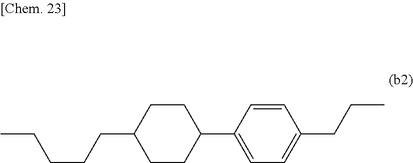 [SMILES: CCCCCC1CCC(c2ccc(CCC)cc2)CC1]

In the case in which the compound represented by the formula (b2) is contained, the content thereof in the liquid crystal composition is preferably 1% to 20%, more preferably 2% to 15%, and further preferably 4% to 10%.

The component (B) may additionally contain a compound represented by the following formula (b3).

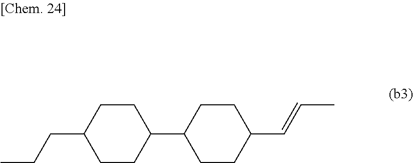 [SMILES: C/C=C/C1CCC(C2CCC(CCC)CC2)CC1]

In the case in which the compound represented by the formula (b3) is contained, the content thereof in the liquid crystal composition is preferably 1% to 20%, more preferably 5% to 15%, and further preferably 8% to 12%.

### <<Mixing Rate of Component (A) to Component (B)>>

In the liquid crystal composition, although a content rate (mixing rate) of the dielectrically negative component (A) to the dielectrically neutral component (B) is not particularly limited as long as the liquid crystal composition has a negative dielectric anisotropy, the amount of the component (A) is preferably larger than that of the component (B).

In particular, in the liquid crystal composition, the content of the component (A) having a negative dielectric anisotropy is preferably 50% or more, preferably 60% to 98%, more preferably 65% to 95%, further preferably 70% to 90%, particularly preferably 70% to 87%, and most preferably 70% to 84%. In addition, in the liquid crystal composition, the content of the component (B) is preferably 5% to 45%, more preferably 10% to 40%, further preferably 15% to 35%.

### <<Dielectric Anisotropy (Δ∈)>>

The dielectric anisotropy (Δ∈) of the liquid crystal composition of the present invention is at 25° C., preferably −2.0 to −6.0, more preferably −2.3 to −5.0, and particularly preferably −2.3 to −4.0. In more detail, when the response speed is important, the dielectric anisotropy (Δ∈) is preferably −2.3 to −3.4, and when the drive voltage is important, the dielectric anisotropy (Δ∈) is preferably −3.4 to −4.0.

<<Refractive Index Anisotropy (Δn)>>

The refractive index anisotropy (Δn) of the liquid crystal composition of the present invention is at 25° C., preferably 0.08 to 0.13 and particularly preferably 0.09 to 0.12. In more detail, in order to respond to a small cell gap, the refractive index anisotropy (Δn) is preferably 0.10 to 0.12, and in order to respond to a large cell gap, the refractive index anisotropy (Δn) is preferably 0.08 to 0.10.

### <<Rotational Viscosity (γ₁)>>

The rotational viscosity (γ₁) of the liquid crystal composition of the present invention is preferably 240 mPa·s or less, more preferably 165 mPa·s or less, further preferably 160 mPa·s or less, and particularly preferably 155 mPa·s or less.

In the liquid crystal composition of the present invention, Z, which is the function between the rotational viscosity and the refractive index anisotropy, preferably exhibits a specific value.

Z=γ1/Δn² [Eq. 1]

(In the equation, γ₁ represents the rotational viscosity, and Δn represents the refractive index anisotropy.)

Z is preferably 18,000 or less, more preferably 16,000 or less, and particularly preferably 14,000 or less.

### <<Viscosity (η)>>

The viscosity (η) of the liquid crystal composition of the present invention is preferably 26 mPa·s or less, more preferably 24.5 mPa·s, further preferably 22.5 mPa·s or less, and particularly preferably 21 mPa·s or less.

When the liquid crystal composition of the present invention is used for an active matrix display element, the specific resistance of the composition is preferably 10¹¹ (Ω·m) or more, more preferably 10¹² (Ω·m) or more, further preferably 10¹³ (Ω·m) or more, and particularly preferably 10¹⁴ (Ω·m) or more.

### <<Other Component: Component (C)>>

The liquid crystal composition of the present invention may also contain a component (C) which corresponds not to the component (A) or (B). Although the content of the component (C) in the liquid crystal composition is not particularly limited, the content thereof is preferably 20% or less, preferably 1% to 10%, and further preferably 1% to 6%.

As the component (C), a compound having a positive dielectric anisotropy may be contained, and for example, a compound represented by the following formula (c1) may be contained.

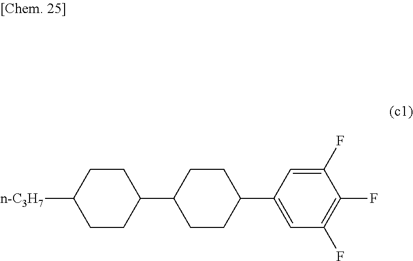

When the compound represented by the formula (c1) is contained, the content thereof in the liquid crystal composition is preferably 1% to 20%, more preferably 2% to 10%, and further preferably 3% to 7%.

In accordance with the application, the liquid crystal composition of the present invention may contain, besides the compounds described above, a common nematic liquid crystal, smectic liquid crystal, cholesteric liquid crystal, antioxidant, UV absorber, polymerizable monomer, and/or the like.

As the polymerizable monomer, a bifunctional monomer represented by the following general formula (VI) is preferable.

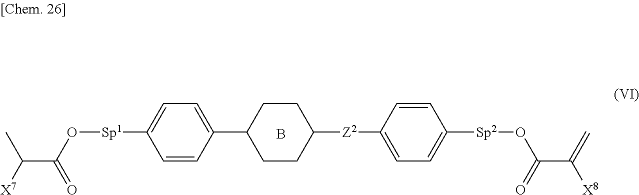

(In the formula, X⁷ and X⁸ each independently represent a hydrogen atom or a methyl group, Sp¹ and Sp² each independently represent a single bond, an alkylene group having 1 to 8 carbon atoms, or —O—(CH₂)ₛ— (in the formula, s represents an integer of 2 to 7, and the oxygen atom is to be bonded to the aromatic ring); Z² represents —OCH₂—, —CH₂O—, —COO—, —OCO—, —CF₂O—, —OCF₂—, —CH₂CH₂—, —CF₂CF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CY¹═CY²— (in the formula, Y¹ and Y² each independently represent a fluorine atom or a hydrogen atom), —C≡C—, or a single bond; and
B represents a 1,4-phenylene group, a trans-1,4-cyclohexylene group, or a single bond, and in all the 1,4-phenylene groups in the formula, an arbitral hydrogen atom may be substituted by a fluorine atom.)

The bifunctional monomer represented by the general formula (VI) is preferably a diacrylate derivative in which X⁷ and X⁸ each represent a hydrogen atom, a dimethacrylate derivative in which X⁷ and X⁸ each represent a methyl group, or a compound in which one of X⁷ and X⁸ represents a hydrogen atom, and the other represents a methyl group. Among those described above, the polymerization rate of the diacrylate derivative is fastest, the polymerization rate of the dimethacrylate derivative is slow, and the polymerization rate of the asymmetrical compound is therebetween, so that in accordance with the application, a preferable mode may be selected. In a PSA display element, the dimethacrylate derivative is particularly preferable.

Although Sp¹ and Sp² each independently represent a single bond, an alkylene group having 1 to 8 carbon atoms, or —O—(CH₂)ₛ—, in a PSA display element, at least one of Sp¹ and Sp² preferably represents a single bond, and a compound in which both of them each represent a single bond or a mode in which one of Sp¹ and Sp² represents a single bond and the other represents an alkylene group having 1 to 8 carbon atoms or —O—(CH₂)ₛ— is preferable. In this case, an alkyl group having 1 to 4 carbon atoms is preferable, and s preferably represents 1 to 4.

Z² represents preferably —OCH₂—, —CH₂O—, —COO—, —OCO—, —CF₂O—, —OCF₂—, —CH₂CH₂—, —CF₂CF₂—, or a single bond, more preferably —COO—, —OCO—, or a single bond, and particularly preferably a single bond.

Although B may represent one of a 1,4-phenylene group and a trans-1,4-cyclohexylene group, in each of which an arbitrary hydrogen atom may be substituted by a fluorine atom, or a single bond, a 1,4-phenylene group or a single bond is preferable. When B represents a ring structure other than a single bond, Z² also preferably represents a linking group other than a single bond, and when B represents a single bond, Z² preferably represents a single bond.

From the points described above, in the general formula (VI), in particular, the ring structure between Sp¹ and Sp² preferably has the following structure.

In the general formula (VI), when B represents a single bond, and the ring structure is formed from two rings, the above ring structure is represented preferably by one of the following formulas (VIa-1) to (VIa-5), more preferably by one of the formulas (VIa-1) to (VIa-3), and particularly preferably by the formula (VIa-1).

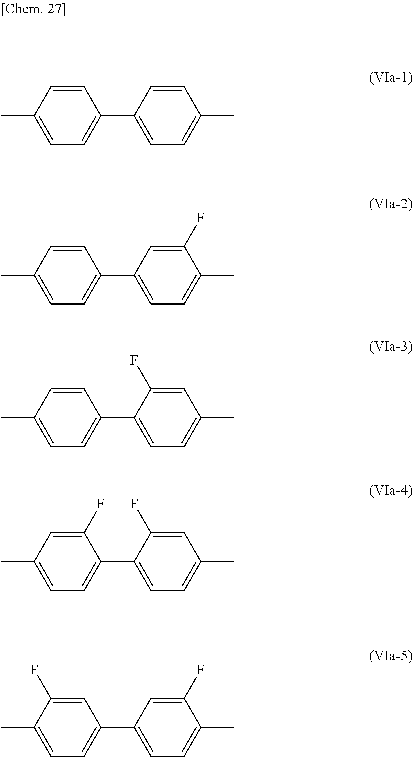

(In the formulas, the two ends are to be bonded to Sp¹ or Sp².)

Since an alignment regulation force obtained after a polymerizable compound having one of those skeletons is polymerized is most preferable for a PSA liquid crystal display element, and a preferable alignment state can be obtained, generation of display irregularities is suppressed or completely prevented.

As described above, as the polymerizable monomer, compounds represented by the following general formulas (VI-1) to (VI-4) are particularly preferable, and the compound represented by the general formula (VI-2) is most preferable.

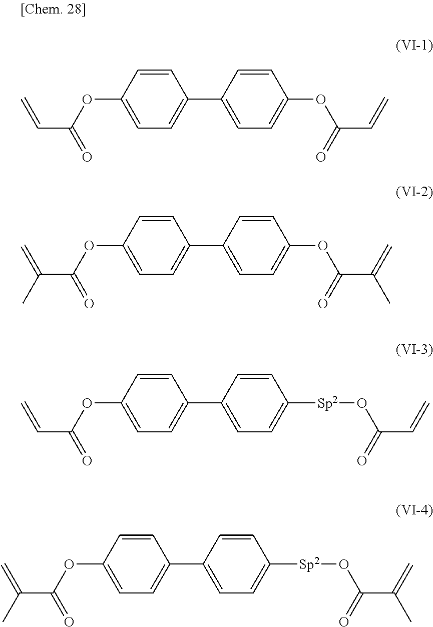

(In the formula, Sp² represents an alkylene group having 2 to 5 carbon atoms.)

As the polymerizable monomer, when the bifunctional monomer represented by the general formula (VI) is used, the content of the bifunctional monomer in the liquid crystal composition is preferably 2% or less, more preferably 1.5% or less, further preferably 1% or less, particularly preferably 0.5% or less, and most preferably 0.4% or less. When the content is 2% or less, the generation of the dropping marks can be suppressed.

When the monomer is added to the liquid crystal composition of the present invention, although polymerization proceeds without using a polymerization initiator, a polymerization initiator may be contained in order to promote the polymerization. As the polymerization initiator, a benzoin ether, a benzophenone, an acetophenone, a benzyl ketal, an acyl phosphine oxide, and the like may be mentioned. In addition, in order to improve storage stability, a stabilizer may also be added. As usable stabilizers, for example, a hydroquinone, a hydroquinone monoalkyl ether, a tertiary butyl catechol, a pyrogallol, a thiophenol, a nitro compound, a β-naphthylamine, a β-naphthol, a nitroso compound, and the like may be mentioned.

The polymerizable compound-containing liquid crystal composition of the present invention is useful for a liquid crystal display element, is particularly useful for an active matrix drive liquid crystal display element, and can be used for a PSA mode, a PSVA mode, a VA mode, an IPS mode, or an ECB mode liquid crystal display element.

Since the polymerizable compound contained in the polymerizable compound-containing liquid crystal composition of the present invention is polymerized by UV irradiation, a liquid crystal alignment ability is imparted thereto, and the liquid crystal composition is used for a liquid crystal display element which controls a light transmission amount by the use of the birefringence of the liquid crystal composition. The above liquid crystal composition is useful for liquid crystal display elements, such as an AM-LCD (active matrix liquid crystal display element), a TN (nematic liquid crystal display element), an STN-LCD (super twisted nematic liquid crystal display element), an OCB-LCD, and an IPS-LCD (in-plane switching liquid crystal display element), and in particular, is useful for an AM-LCD. In addition, the liquid crystal composition described above may be used for either a transmission type or a reflection type liquid crystal display element.

As two substrates of a liquid crystal cell used for a liquid crystal display element, a transparent material, such as glass or a flexible plastic, may be used, and an opaque material, such as silicon, may also be used for one of the two substrates. A transparent substrate having a transparent electrode layer may be obtained, for example, by sputtering indium tin oxide (ITO) on a transparent substrate such as a glass plate.

The substrates are arranged to face each other so that a transparent electrode layer is disposed therebetween. In this step, the gap between the substrates may be controlled with spacers interposed therebetween. In this case, the thickness of an obtained light controlling layer is preferably controlled to 1 to 100 μm. The thickness described above is more preferably controlled to 1.5 to 10 μm, and when a polarizer is used, the product of the refractive index anisotropy Δn and the cell thickness d is preferably controlled to maximize the contrast. In addition, when two polarizers are used, the polarization axis of each polarizer may be controlled so as to obtain preferable viewing angle and contrast. Furthermore, in order to increase the viewing angle, a retardation film may also be used. As the spacers, for example, glass particles, plastic particles, alumina particles, and a photoresist material may be mentioned. Subsequently, after a sealing agent, such as an epoxy-based thermosetting composition, is screen-printed on the substrates so as to provide a liquid crystal inlet port, the substrates are adhered to each other, and the sealing agent is then thermally cured by heating.

As a method to provide the polymerizable compound-containing liquid crystal composition between the two substrates, a common vacuum injection method or a common ODF method may be used. However, although the dropping marks are not generated by a vacuum injection method, an injection mark is disadvantageously generated thereby. The present invention may be more preferably applied to display elements manufactured using an ODF method.

As a method to polymerize the polymerizable compound, in order to obtain a preferable alignment ability of liquid crystal, a method capable of obtaining an appropriate polymerization rate is preferable. In particular, a polymerization method which uses active energy rays, such as ultraviolet rays and electron rays, alone or in combination or a polymerization method which sequentially uses a plurality of active energy rays may be preferable. When ultraviolet rays are used, either a polarization light source or a non-polarization light source may be used. In addition, when the polymerizable compound-containing liquid crystal composition provided between the two substrates is polymerized, appropriate transparency to active energy rays must be imparted to at least one of the substrates located at an irradiation surface side. In addition, a method may also be used in which after a specific portion is only polymerized using a mask during light irradiation, the alignment condition of a non-polymerized portion is changed by changing conditions of the electric field, the magnetic field, and/or the temperature, and polymerization is then performed by further irradiation of active energy rays. In particular, in the case of ultraviolet-ray exposure, ultraviolet-ray exposure is preferably performed while an alternating electrical current is applied to the polymerizable compound-containing liquid crystal composition. The alternating electrical current to be applied is preferably an alternating electrical current at a frequency of 10 Hz to 10 kHz and more preferably at a frequency of 60 Hz to 10 kHz. The voltage is selected depending on a desired pretilt angle of a liquid crystal display element. That is, by the voltage to be applied, the pretilt angle of a liquid crystal display element can be controlled. In a MVA mode liquid crystal display element, in view of the alignment stability and contrast, the pretilt angle is preferably controlled to 80° to 89.9°.

The temperature during irradiation is preferably in a temperature range in which the liquid crystal state of the liquid crystal composition of the present invention is maintained. Polymerization is preferably performed at a temperature close to room temperature, that is, typically, at a temperature of 15° C. to 35° C. As a lamp generating ultraviolet rays, for example, a metal halide lamp, a high-pressure mercury lamp, and an ultra high-pressure mercury lamp may be used. In addition, as the wavelength of ultraviolet rays to be irradiated, ultraviolet rays having a wavelength region other than the absorption wavelength region of the liquid crystal composition are preferably irradiated, and whenever necessarily, light from which ultraviolet rays are cut off is preferably used. The intensity of ultraviolet rays to be irradiated is preferably 0.1 mW/cm² to 100 W/cm² and more preferably 2 mW/cm² to 50 W/cm². Although the energy amount of ultraviolet rays to be irradiated may be appropriately controlled, an energy amount of 10 mJ/cm² to 500 J/cm² is preferable, and an energy amount of 100 mJ/cm² to 200 J/cm² is more preferable. When ultraviolet rays are irradiated, the intensity thereof may be changed. Although the time for ultraviolet ray irradiation is appropriately selected in accordance with the intensity of ultraviolet rays to be irradiated, a time of 10 to 3,600 seconds is preferable, and a time of 10 to 600 seconds is more preferable.

### <<Liquid Crystal Display Element>>

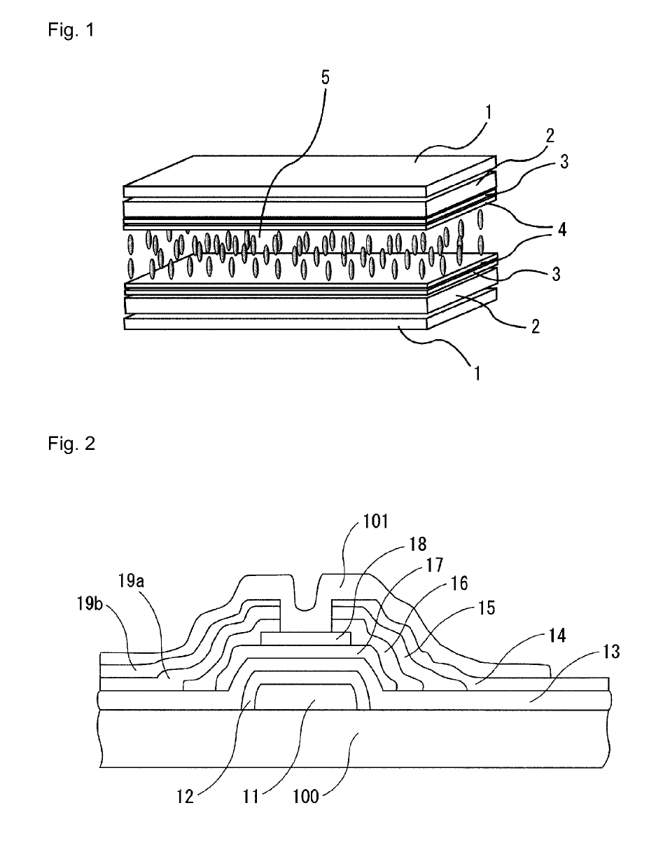

The structure of a liquid crystal display element according to a second embodiment of the present invention preferably comprises, as shown in FIG. 1, a first substrate including a common electrode formed from an electrically conductive transparent material; a second substrate including pixel electrodes each formed from an electrically conductive transparent material and thin film transistors, each of which controls a pixel electrode provided in each pixel; and a liquid crystal composition provided between the first substrate and the second substrate. As the liquid crystal composition, the liquid crystal composition of the first embodiment is used. In this liquid crystal display element, the alignment of liquid crystal molecules is approximately perpendicular to the substrate during no voltage application.

As described above, the generation of dropping marks is significantly influenced by the types of liquid crystal compounds forming a liquid crystal material (liquid crystal composition) to be charged and the combination therebetween. Furthermore, the types of members forming a display element and the combination therebetween may also have influences on the generation of dropping marks in some cases. In particular, since members, such as an alignment film and a transparent electrode, which are formed in a liquid crystal display element and which separate the liquid crystal composition from a color filter and a thin film transistor, are members having a small thickness, the color filter and/or the thin film transistor may probably influence the liquid crystal composition and generate dropping marks in some cases.

In addition, when the thin film transistor in a liquid crystal display element is a reverse staggered transistor, since the drain electrode is formed so as to cover the gate electrode, the area of the thin film transistor tends to increase. The drain electrode is formed of a metal material, such as copper, aluminum, chromium, titanium, molybdenum, or tantalum, and is generally processed by a passivation treatment. However, since a protective film is generally thin, the alignment film is also thin, and an ionic material may not be blocked thereby with high probability, when a related liquid crystal composition is used, the generation of dropping marks caused by the interaction between the metal material and the liquid crystal composition frequently occurred in the past.

On the other hand, as shown in the results of evaluation of dropping mark performed in the following examples, when the liquid crystal composition according to the first embodiment of the present invention is used, although a detailed mechanism thereof has not been understood yet, the generation of dropping marks, which has been the problem, can be sufficiently suppressed.

The liquid crystal composition according to the first embodiment of the present invention is suitable, for example, for a liquid crystal display element in which as shown in FIG. 2, the thin film transistor is a reverse staggered transistor. In this case, aluminum wires are preferably used.

The liquid crystal display element using the liquid crystal composition according to the first embodiment of the present invention is effective to simultaneously satisfy a high speed response and suppression of display defects, is particularly useful for an active matrix drive liquid crystal display element, and may be applied to a VA mode, a PSVA mode, a PSA mode, an IPS mode, or an ECB mode liquid crystal display element.

A liquid crystal display of the present invention is a display (display device) to which the liquid crystal display element of the present invention is applied by a known method.

### EXAMPLES

Hereinafter, although the present invention will be described in more detail with reference to examples, the present invention is not limited thereto. In addition, “%” described in the compositions of the following examples and comparative examples represents “percent by mass”.

The characteristics measured in the examples are as follows.

Tₙᵢ: nematic phase-isotropic liquid phase transition temperature (° C.)

Δn: refractive index anisotropy at 25° C.

Δ∈: dielectric anisotropy at 25° C.

η: viscosity (mPa·s) at 20° C.

γ₁: rotational viscosity (mPa·s) at 25° C.

Initial voltage retention (initial VHR): voltage retention (%) at 60° C. at a frequency of 60 Hz and an applied voltage of 1 V.

Voltage retention at 150° C. after 1 hour: voltage retention (%) measured under the same conditions as those of the initial VHR after storage is performed at 150° C. for 1 hour.

### [Evaluation of Burn-in]

For evaluation of burn-in of a liquid crystal display element, after a predetermined fixed pattern was displayed in a display area for 1,000 hours, an entirely uniform display was performed, and the level of a residual image of the fixed pattern was evaluated by visual inspection in accordance with the following four criteria.

⊚: No residual image

∘: A residual image slightly remains but is allowable.

Δ: A residual image remains and is not allowable.

x: A residual image remains and is considerably inferior.

### [Evaluation of Dropping Marks]

For evaluation of dropping marks of a liquid crystal display device, dropping marks which emerged white when entirely black display was performed were evaluated by visual inspection in accordance with the following four criteria.

⊚: No residual image

∘: A residual image slightly remains but is allowable.

Δ: A residual image remains and is not allowable.

x: A residual image remains and is considerably inferior.

### [Evaluation of Process Applicability]

For process applicability, after 50 pL of a liquid crystal was dropped 100,000 times in an ODF process using a constant volume metering pump, the total amount of the liquid crystal obtained by 100 times of dropping was measured each from “0th to 100th, from 101th to 200th, from 201th to 300th, - - - , and from 99,901th to 100,000th dropping”, and the change in amount of the liquid crystal was evaluated in accordance with the following four criteria.

⊚: Change is significantly small (liquid crystal display elements can be stably manufactured).

∘: Change is slightly observed but is allowable.

Δ: Change is observed and is not allowable (yield is degraded because of generation of marks).

x: Change is observed and is considerably inferior (liquid crystal leaks and/or vacuum bubbles are generated).

### [Evaluation of Solubility at Low Temperature]

For evaluation of solubility at a low temperature, after a liquid crystal composition was prepared, 1 g of the liquid crystal composition was measured and charged in a 2-mL sample bottle, and this sample was processed in a temperature-control test bath by continuously applying the following temperature change. The temperature change was performed as one cycle from “−20° C. (held for 1 hour)→temperature rise (0.1° C./min)→0° C. (held for 1 hour)→temperature rise (0.1° C./min)→20° C. (held for 1 hour)→temperature fall (−0.1° C./min)→0° C. (held for 1 hour)→temperature fall (−0.1° C./min)→−20° C.”. The generation of precipitates from the liquid crystal composition was observed by visual inspection and was evaluated in accordance with the following four criteria.

⊚: No precipitates are observed for 600 hours or more.

∘: No precipitates are observed for 300 hours or more.

Δ: Precipitates are observed within 150 hours.

x: Precipitates are observed within 75 hours.

### Example 1, Comparative Example 1

Liquid crystal compositions having compositions shown in Table 1 were prepared, and the physical properties thereof were measured.

In addition, by the use of each of the liquid crystal compositions of Example 1 and Comparative Example 1, a VA liquid crystal display element shown in FIG. 1 was formed. This liquid crystal display element included a reverse staggered thin film transistor as an active element. The charge of the liquid crystal composition was performed by a dropping method (ODF method). Furthermore, by the methods described above, the evaluations of burn-in, dropping marks, process applicability, and solubility at a low temperature were performed on the display element thus obtained. The results are shown in Table 2.

TABLE 1

Rate (%)

| Chemical | | Comparative |
|---|---|---|
| formula | Example 1 | Example 1 |
| (b3) | | 13 |
| (b4) | | 15 |
| (1) | 10 | |
| (8.2) | 10 | |
| (8.1) | 6 | |
| (2.1) | 11 | 11 |
| (9.1) | 12 | 12 |
| (5.2) | 5 | 5 |
| (3.1) | 12 | 12 |
| (3.2) | 12 | 12 |
| (4.1) | 12 | 10 |
| (4.2) | 10 | 10 |
| Tₙᵢ (° C.) | 80.5 | 80.5 |
| Δn | 0.1262 | 0.1271 |
| Δε | −3.62 | −3.60 |
| η/mPa · s | 17.0 | 18.2 |
| γ₁/mPa · s | 137 | 145 |

In Table 1, the compound represented by the chemical formula (b4) of Comparative Example 1 is a compound represented by the following structural formula (b4).

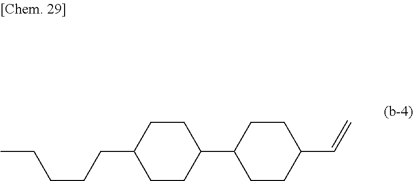 [SMILES: C=CC1CCC(C2CCC(CCCCC)CC2)CC1]

TABLE 2

| | | Comparative |
|---|---|---|
| | Example 1 | Example 1 |
| Initial voltage retention (%) | 99.5 | 98.5 |
| Voltage retention at 150° C. after 1 hour (%) | 98.9 | 96.4 |
| Evaluation of burn-in | ⊙ | X |
| Evaluation of dropping marks | ⊙ | Δ |
| Evaluation of process applicability | ⊙ | Δ |
| Evaluation of solubility at low temperature | ⊙ | ⊙ |

The liquid crystal composition of Example 1 has a practical liquid crystal phase temperature range of 80.5° C. as a liquid crystal composition for TV application, a high dielectric anisotropy absolute value, a low rotational viscosity, and an optimum Δn. In addition, the solubility at a low temperature is also excellent. Furthermore, the VA liquid crystal display element having the structure shown in FIG. 1 formed using the liquid crystal composition of Example 1 also showed significantly excellent results of the evaluations of burn-in, dropping marks, and process applicability. The VA liquid crystal display element described above was also excellent in initial voltage retention and voltage retention at 150° C. after 1 hour.

### Example 2, Comparative Example 2

Liquid crystal compositions having compositions shown in Table 3 were prepared, and the physical properties thereof were measured.

In addition, by the use of each of the liquid crystal compositions of Example 2 and Comparative Example 2, a display element was formed in a manner similar to that of Example 1, and the evaluations of burn-in, dropping marks, process applicability, and solubility at a low temperature were performed on the display element thus obtained. The results are shown in Table 4.

TABLE 3

Rate (%)

| Chemical | | Comparative |
|---|---|---|
| formula | Example 2 | Example 2 |
| (1) | 11 | 11 |
| (8.3) | 4 | 4 |
| (8.5) | 5 | 5 |
| (b1) | 4 | 4 |
| (2.1) | 12 | 12 |
| (9.1) | 11 | 11 |
| (5.2) | 14 | |
| (7.1) | | 14 |
| (7.2) | 15 | 15 |
| (10.1) | 10 | 10 |
| (10.2) | 14 | 14 |
| Tₙᵢ (° C.) | 87.3 | 89.0 |
| Δn | 0.0814 | 0.0813 |
| Δε | −4.15 | −4.22 |
| η/mPa · s | 20 | 21 |
| γ₁/mPa · s | 118 | 121 |

TABLE 4

| | | Comparative |
|---|---|---|
| | Example 2 | Example 2 |
| Initial voltage retention (%) | 99.5 | 98.5 |
| Voltage retention at 150° C. after 1 hour (%) | 98.9 | 96.4 |
| Evaluation of burn-in | ⊙ | Δ |
| Evaluation of dropping marks | ⊙ | ◯ |
| Evaluation of process applicability | ⊙ | ⊙ |
| Evaluation of solubility at low temperature | ⊙ | X |

The liquid crystal composition of Example 2 has a practical liquid crystal phase temperature range of 87.3° C. as a liquid crystal composition for TV application, and the refractive index anisotropy and the dielectric anisotropy are also excellent. In addition, the solubility at a low temperature is also excellent. Furthermore, the VA liquid crystal display element having the structure shown in FIG. 1 formed using the liquid crystal composition of Example 2 also showed significantly excellent results of the evaluations of burn-in, dropping marks, and process applicability. The VA liquid crystal display element described above was also excellent in initial voltage retention and voltage retention at 150° C. after 1 hour.

### Examples 3 to 6

Liquid crystal compositions having compositions shown in Table 5 were prepared, and the physical properties thereof were measured.

In addition, by the use of each of the liquid crystal compositions of Examples 3 to 6, a display element was formed in a manner similar to that of Example 1, and the evaluations of burn-in, dropping marks, process applicability, and solubility at a low temperature were performed on the display element thus obtained. The results are shown in Table 6.

TABLE 5

Rate (%)

| Chemical | Exam- | Exam- | Exam- | Exam- |
|---|---|---|---|---|
| formula | ple 3 | ple 4 | ple 5 | ple 6 |
| (8.1) | 23 | 18 | 23 | 23 |
| (1) | 10 | 10 | 10 | 10 |
| (8.2) | | 5 | | |
| (6.1) | 7 | 7 | 7 | 7 |
| (2.1) | 13 | 13 | 8 | 13 |
| (9.1) | | | 5 | |
| (3.1) | 9 | 9 | 9 | 6 |
| (3.2) | 9 | 9 | 9 | 6 |
| (a1) | | | | 6 |
| (5.2) | | | | 5 |
| (7.1) | 9 | 9 | 9 | 4 |
| (7.2) | 5 | 5 | 5 | 5 |
| (a2) | | | | 5 |
| (4.1) | 7 | 7 | 7 | 5 |
| (4.2) | 8 | 8 | 8 | 5 |
| Tₙᵢ (° C.) | 78.7 | 81.3 | 79.5 | 78.3 |
| Δn | 0.110 | 0.111 | 0.110 | 0.109 |
| Δε | −2.67 | −2.68 | −2.64 | −2.65 |
| η/mPa · s | 20.6 | 22.0 | 21.0 | 20.5 |
| γ₁/mPa · s | 151 | 160 | 157 | 151 |

TABLE 6

| | Exam- | Exam- | Exam- | Exam- |
|---|---|---|---|---|
| | ple 3 | ple 4 | ple 5 | ple 6 |
| Initial voltage retention (%) | 99.1 | 99.1 | 99.2 | 99.4 |
| Voltage retention at 150° C. | 98.1 | 98.3 | 98.2 | 98.4 |
| after 1 hour (%) | | | | |
| Evaluation of burn-in | ⊙ | ⊙ | ◯ | ⊙ |
| Evaluation of dropping marks | ⊙ | ◯ | ⊙ | ⊙ |
| Evaluation of process | ⊙ | ◯ | ◯ | ◯ |
| applicability | | | | |
| Evaluation of solubility at low | ⊙ | ◯ | ⊙ | ⊙ |
| temperature | | | | |

The liquid crystal compositions of Examples 3 to 6 have a practical liquid crystal phase temperature range of 78.3° C. to 81.3° C. as a liquid crystal composition for TV application, and the refractive index anisotropy and the dielectric anisotropy are also excellent. The liquid crystal compositions of Examples 3, 5, and 6 each showed a significantly excellent result of the evaluation of solubility at a low temperature.

The VA liquid crystal display element of Example 3 showed significantly excellent results of the evaluations of burn-in, dropping marks, and process applicability. The VA liquid crystal display element of Example 4 showed a significantly excellent result of the evaluation of burn-in. The VA liquid crystal display element of Example 5 showed a significantly excellent result of the evaluation of dropping marks. The VA liquid crystal display element of Example 6 showed significantly excellent results of the evaluations of burn-in and dropping marks.

The VA liquid crystal display elements of Examples 3 to 6 each showed excellent results of the initial voltage retention and the voltage retention at 150° C. after 1 hour.

### Examples 7 to 10

Liquid crystal compositions having compositions shown in Table 7 were prepared, and the physical properties thereof were measured.

In addition, by the use of each of the liquid crystal compositions of Examples 7 to 10, a display element was formed in a manner similar to that of Example 1, and the evaluations of burn-in, dropping marks, process applicability, and solubility at a low temperature were performed on the display element thus obtained. The results are shown in Table 8.

TABLE 7

Rate (%)

| Chemical | Exam- | Exam- | Exam- | Exam- |
|---|---|---|---|---|
| formula | ple 7 | ple 8 | ple 9 | ple 10 |
| (8.1) | 24 | 18 | 18 | 24 |
| (1) | 12 | 12 | 12 | 12 |
| (8.2) | | 6 | | |
| (6.1) | 8 | 8 | 8 | 8 |
| (6.3) | | | 6 | |
| (2.1) | 13 | 10 | 7 | 13 |
| (2.2) | | 3 | 6 | |
| (3.1) | 5 | 5 | 5 | 5 |
| (3.2) | 9 | 5 | 9 | 9 |
| (a3) | | 4 | | |
| (7.1) | 9 | 9 | 9 | |
| (5.2) | 8 | 8 | 8 | 9 |
| (4.1) | 12 | 6 | 12 | 8 |
| (4.2) | | 6 | | 12 |
| Tₙᵢ (° C.) | 76.6 | 78.4 | 75.5 | 70.3 |
| Δn | 0.101 | 0.101 | 0.104 | 0.111 |
| Δε | −2.48 | −2.45 | −2.51 | −2.18 |
| η/mPa · s | 18.3 | 19.8 | 20.3 | 17.3 |
| γ₁/mPa · s | 134 | 146 | 149 | 132 |

TABLE 8

| | Exam- | Exam- | Exam- | Exam- |
|---|---|---|---|---|
| | ple 7 | ple 8 | ple 9 | ple 10 |
| Initial voltage retention (%) | 99.3 | 99.0 | 99.5 | 99.4 |
| Voltage retention at 150° C. | 98.3 | 98.4 | 98.2 | 98.0 |
| after 1 hour (%) | | | | |
| Evaluation of burn-in | ⊙ | ⊙ | ◯ | ⊙ |
| Evaluation of dropping marks | ⊙ | ◯ | ◯ | ⊙ |
| Evaluation of process | ⊙ | ⊙ | ◯ | ◯ |
| applicability | | | | |
| Evaluation of solubility at low | ⊙ | ⊙ | ⊙ | ◯ |
| temperature | | | | |

The liquid crystal compositions of Examples 7 to 10 have a practical liquid crystal phase temperature range of 70.3° C. to 78.4° C. as a liquid crystal composition for TV application, and the refractive index anisotropy and the dielectric anisotropy are also excellent. The liquid crystal compositions of Examples 7 to 9 each showed a significantly excellent result of the evaluation of solubility at a low temperature.

The VA liquid crystal display element of Example 7 showed significantly excellent results of the evaluations of burn-in, dropping marks, and process applicability. The VA liquid crystal display element of Example 8 showed significantly excellent results of the evaluations of burn-in and process applicability. The VA liquid crystal display element of Example 10 showed significantly excellent results of the evaluations of burn-in and dropping marks.

The VA liquid crystal display elements of Examples 7 to 10 each showed excellent results of the initial voltage retention and the voltage retention at 150° C. after 1 hour.

### Examples 11 to 14

Liquid crystal compositions having compositions shown in Table 9 were prepared, and the physical properties thereof were measured.

In addition, by the use of each of the liquid crystal compositions of Examples 11 to 14, a display element was formed in a manner similar to that of Example 1, and the evaluations of burn-in, dropping marks, process applicability, and solubility at a low temperature were performed on the display element thus obtained. The results are shown in Table 10.

TABLE 9

Rate (%)

| Chemical | Exam- | Exam- | Exam- | Exam- |
|---|---|---|---|---|
| formula | ple 11 | ple 12 | ple 13 | ple 14 |
| (8.1) | 27 | 27 | 28 | 27 |
| (1) | 10 | 14 | 13 | 10 |
| (6.1) | 7 | 3 | 3 | 7 |
| (2.1) | 14 | 8 | 14 | 14 |
| (2.2) | | 6 | | |
| (3.1) | 5 | 5 | | 5 |
| (3.2) | 11 | 11 | 11 | |
| (a3) | | | 5 | 11 |
| (7.1) | 9 | 9 | 9 | 3 |
| (5.2) | 8 | 8 | 8 | 8 |
| (4.1) | 9 | 9 | | 9 |
| (4.2) | | | 9 | 6 |
| Tₙᵢ (° C.) | 75.9 | 78.5 | 77.9 | 70.1 |
| Δn | 0.097 | 0.095 | 0.093 | 0.103 |
| Δε | −2.59 | −2.59 | −2.60 | −2.35 |
| η/mPa · s | 17.9 | 18.0 | 17.2 | 16.2 |
| γ₁/mPa · s | 128 | 131 | 124 | 126 |

TABLE 10

| | Exam- | Exam- | Exam- | Exam- |
|---|---|---|---|---|
| | ple 11 | ple 12 | ple 13 | ple 14 |
| Initial voltage retention (%) | 99.6 | 99.0 | 99.3 | 99.0 |
| Voltage retention at 150° C. | 98.8 | 98.1 | 98.2 | 98.0 |
| after 1 hour (%) | | | | |
| Evaluation of burn-in | ⊙ | ⊙ | ⊙ | ⊙ |
| Evaluation of dropping marks | ⊙ | ⊙ | ◯ | ⊙ |
| Evaluation of process | ⊙ | ⊙ | ◯ | ◯ |
| applicability | | | | |
| Evaluation of solubility at low | ⊙ | ⊙ | ⊙ | ⊙ |
| temperature | | | | |

The liquid crystal compositions of Examples 11 to 14 have a practical liquid crystal phase temperature range of 70.1° C. to 78.5° C. as a liquid crystal composition for TV application, and the refractive index anisotropy and the dielectric anisotropy are also excellent. The liquid crystal compositions of Examples 11 to 14 each showed a significantly excellent result of the evaluation of solubility at a low temperature.

The VA liquid crystal display elements of Examples 11 and 12 showed significantly excellent results of the evaluations of burn-in, dropping marks, and process applicability. The VA liquid crystal display element of Example 13 showed a significantly excellent result of the evaluation of burn-in. The VA liquid crystal display element of Example 14 showed significantly excellent results of the evaluations of burn-in and dropping marks.

The VA liquid crystal display elements of Examples 11 to 14 each showed excellent results of the initial voltage retention and the voltage retention at 150° C. after 1 hour.

### Examples 15 to 18

Liquid crystal compositions having compositions shown in Table 11 were prepared, and the physical properties thereof were measured.

In addition, by the use of each of the liquid crystal compositions of Examples 15 to 18, a display element was formed in a manner similar to that of Example 1, and the evaluations of burn-in, dropping marks, process applicability, and solubility at a low temperature were performed on the display element thus obtained. The results are shown in Table 12.

TABLE 11

Rate (%)

| Chemical | Exam- | Exam- | Exam- | Exam- |
|---|---|---|---|---|
| formula | ple 15 | ple 16 | ple 17 | ple 18 |
| (1) | 9 | 9 | 9 | 9 |
| (8.2) | 10 | 10 | 10 | |
| (6.1) | 6 | 6 | 6 | 6 |
| (b2) | 9 | 9 | 9 | 9 |
| (b3) | | | | 10 |
| (2.2) | | 14 | | |
| (9.2) | | 13 | 14 | |
| (2.1) | 14 | | | 14 |
| (9.1) | 13 | | 13 | 13 |
| (5.1) | 11 | 11 | | 11 |
| (7.2) | 11 | 11 | 9 | 11 |
| (10.1) | 9 | 9 | | 9 |
| (10.2) | 8 | 8 | 8 | 8 |
| (4.1) | | | 11 | |
| (4.2) | | | 11 | |
| Tₙᵢ (° C.) | 70.8 | 69.6 | 65.3 | 70.7 |
| Δn | 0.082 | 0.080 | 0.112 | 0.084 |
| Δε | −3.21 | −3.00 | −2.38 | −3.37 |
| η/mPa · s | 22.1 | 23.1 | 20.8 | 20.6 |
| γ₁/mPa · s | 107 | 129 | 136 | 101 |

TABLE 12

| | Exam- | Exam- | Exam- | Exam- |
|---|---|---|---|---|
| | ple 15 | ple 16 | ple 17 | ple 18 |
| Initial voltage retention (%) | 99.7 | 99.1 | 99.5 | 99.2 |
| Voltage retention at 150° C. | 99.0 | 98.1 | 98.2 | 98.3 |
| after 1 hour (%) | | | | |
| Evaluation of burn-in | ⊙ | ⊙ | ⊙ | ◯ |
| Evaluation of dropping marks | ⊙ | ⊙ | ◯ | ◯ |
| Evaluation of process | ⊙ | ◯ | ⊙ | ⊙ |
| applicability | | | | |
| Evaluation of solubility at low | ⊙ | ⊙ | ◯ | ⊙ |
| temperature | | | | |

The liquid crystal compositions of Examples 15 to 18 have a practical liquid crystal phase temperature range of 65.3° C. to 70.8° C. as a liquid crystal composition for TV application, and the refractive index anisotropy and the dielectric anisotropy are also excellent. The liquid crystal compositions of Examples 15, 16, and 18 each showed a significantly excellent result of the evaluation of solubility at a low temperature.

The VA liquid crystal display element of Example 15 showed significantly excellent results of the evaluations of burn-in, dropping marks, and process applicability. The VA liquid crystal display element of Example 16 showed significantly excellent results of the evaluations of burn-in and dropping marks. The VA liquid crystal display element of Example 17 showed significantly excellent results of the evaluations of burn-in and process applicability. The VA liquid crystal display element of Example 18 showed a significantly excellent result of the evaluation of process applicability.

The VA liquid crystal display elements of Examples 15 to 18 each showed excellent results of the initial voltage retention and the voltage retention at 150° C. after 1 hour.

### Examples 19 to 22

Liquid crystal compositions having compositions shown in Table 13 were prepared, and the physical properties thereof were measured.

In addition, by the use of each of the liquid crystal compositions of Examples 19 to 22, a display element was formed in a manner similar to that of Example 1, and the evaluations of burn-in, dropping marks, process applicability, and solubility at a low temperature were performed on the display element thus obtained. The results are shown in Table 14.

TABLE 13

Rate (%)

| Chemical | Exam- | Exam- | Exam- | Exam- |
|---|---|---|---|---|
| formula | ple 19 | ple 20 | ple 21 | ple 22 |
| (1) | 10 | 22 | 10 | 14 |
| (8.1) | 22 | 10 | 22 | 19 |
| (8.2) | | | | 2 |
| (3.2) | 12 | 12 | 12 | 12 |
| (3.1) | 12 | 12 | 12 | 12 |
| (9.1) | 5 | 4 | 3 | 2 |
| (2.1) | 15 | 16 | 17 | 18 |
| (5.1) | 11 | 11 | 11 | |
| (5.2) | | | | 11 |
| (4.2) | | | 7 | |
| (4.1) | 7 | 7 | | 7 |
| (c1) | 6 | 6 | 6 | 4 |
| Tₙᵢ (° C.) | 75.3 | 80.2 | 74.5 | 78.4 |
| Δn | 0.100 | 0.102 | 0.099 | 0.101 |
| Δε | −2.73 | −2.92 | −2.73 | −3.02 |
| η/mPa · s | 22.0 | 24.3 | 22.3 | 22.5 |
| γ₁/mPa · s | 120 | 130 | 120 | 134 |

TABLE 14

| | Exam- | Exam- | Exam- | Exam- |
|---|---|---|---|---|
| | ple 19 | ple 20 | ple 21 | ple 22 |
| Initial voltage retention (%) | 99.6 | 99.0 | 99.3 | 99.0 |
| Voltage retention at 150° C. | 98.8 | 98.0 | 98.2 | 98.1 |
| after 1 hour (%) | | | | |
| Evaluation of burn-in | ⊙ | ⊙ | ⊙ | ⊙ |
| Evaluation of dropping marks | ⊙ | ⊙ | ◯ | ⊙ |
| Evaluation of process | ⊙ | ⊙ | ◯ | ◯ |
| applicability | | | | |
| Evaluation of solubility at low | ⊙ | ⊙ | ⊙ | ⊙ |
| temperature | | | | |

The liquid crystal compositions of Examples 19 to 22 have a practical liquid crystal phase temperature range of 74.5° C. to 80.2° C. as a liquid crystal composition for TV application, and the refractive index anisotropy and the dielectric anisotropy are also excellent. The liquid crystal compositions of Examples 19 to 22 each showed a significantly excellent result of the evaluation of solubility at a low temperature.

The VA liquid crystal display elements of Examples 19 and 20 each showed significantly excellent results of the evaluations of burn-in, dropping marks, and process applicability. The VA liquid crystal display element of Example 21 showed a significantly excellent result of the evaluation of burn-in. The VA liquid crystal display element of Example 22 showed significantly excellent results of the evaluations of burn-in and dropping marks.

The VA liquid crystal display elements of Examples 19 to 22 each showed excellent results of the initial voltage retention and the voltage retention at 150° C. after 1 hour.

### Examples 23 to 26

Liquid crystal compositions having compositions shown in Table 15 were prepared, and the physical properties thereof were measured.

In addition, by the use of each of the liquid crystal compositions of Examples 23 to 26, a display element was formed in a manner similar to that of Example 1, and the evaluations of burn-in, dropping marks, process applicability, and solubility at a low temperature were performed on the display element thus obtained. The results are shown in Table 16.

TABLE 15

Rate (%)

| Chemical | Exam- | Exam- | Exam- | Exam- |
|---|---|---|---|---|
| formula | ple 23 | ple 24 | ple 25 | ple 26 |
| (5.1) | 10 | 9 | 10 | 7 |
| (5.2) | | | | 3 |
| (2.1) | 15 | 15 | 15 | 15 |
| (8.3) | 4 | 4 | 4 | 4 |
| (8.1) | 23 | 24 | 21 | 20 |
| (1) | 11 | 10 | 13 | 15 |
| (3.1) | 12 | 12 | 12 | 12 |
| (3.2) | 12 | 12 | 12 | 12 |
| (4.1) | 9 | 10 | 6 | 9 |
| (4.2) | | | 3 | |
| (c1) | 4 | 4 | 4 | 3 |
| Tₙᵢ (° C.) | 76.0 | 75.2 | 76.6 | 77.8 |
| Δn | 0.102 | 0.104 | 0.102 | 0.103 |
| Δε | −2.60 | −2.54 | −2.62 | −2.71 |
| η/mPa · s | 20.3 | 20.1 | 20.8 | 20.5 |
| γ₁/mPa · s | 121 | 121 | 123 | 127 |

TABLE 16

| | Exam- | Exam- | Exam- | Exam- |
|---|---|---|---|---|
| | ple 23 | ple 24 | ple 25 | ple 26 |
| Initial voltage retention (%) | 99.1 | 99.1 | 99.2 | 99.4 |
| Voltage retention at 150° C. | 98.1 | 98.3 | 98.2 | 98.4 |
| after 1 hour (%) | | | | |
| Evaluation of burn-in | ⊙ | ⊙ | ◯ | ⊙ |
| Evaluation of dropping marks | ⊙ | ◯ | ⊙ | ⊙ |
| Evaluation of process | ⊙ | ◯ | ◯ | ◯ |
| applicability | | | | |
| Evaluation of solubility at low | ⊙ | ◯ | ⊙ | ⊙ |
| temperature | | | | |

The liquid crystal compositions of Examples 23 to 26 have a practical liquid crystal phase temperature range of 75.2° C. to 77.8° C. as a liquid crystal composition for TV application, and the refractive index anisotropy and the dielectric anisotropy are also excellent. The liquid crystal compositions of Examples 23, 25, and 26 each showed a significantly excellent result of the evaluation of solubility at a low temperature.

The VA liquid crystal display elements of Example 23 showed significantly excellent results of the evaluations of burn-in, dropping marks, and process applicability. The VA liquid crystal display element of Example 24 showed a significantly excellent result of the evaluation of burn-in. The VA liquid crystal display element of Example 25 showed a significantly excellent result of the evaluation of dropping marks. The VA liquid crystal display element of Example 26 showed significantly excellent results of the evaluations of burn-in and dropping marks.

The VA liquid crystal display elements of Examples 23 to 26 each showed excellent results of the initial voltage retention and the voltage retention at 150° C. after 1 hour.

### Examples 27 to 30

Liquid crystal compositions having compositions shown in Table 17 were prepared, and the physical properties thereof were measured.

In addition, by the use of each of the liquid crystal compositions of Examples 27 to 30, a display element was formed in a manner similar to that of Example 1, and the evaluations of burn-in, dropping marks, process applicability, and solubility at a low temperature were performed on the display element thus obtained. The results are shown in Table 18.

TABLE 17

Rate (%)

| Chemical | Exam- | Exam- | Exam- | Exam- |
|---|---|---|---|---|
| formula | ple 27 | ple 28 | ple 29 | ple 30 |
| (2.1) | 13 | 13 | 8 | 8 |
| (2.2) | | | 5 | 5 |
| (6.1) | 8 | 8 | 7 | |
| (8.3) | | | | 7 |
| (8.1) | 23 | 22 | 22 | 22 |
| (1) | 11 | 11 | 11 | 11 |
| (3.1) | 5 | 5 | 5 | 5 |
| (3.2) | 10 | 10 | 10 | 10 |
| (4.1) | 13 | 14 | 15 | 15 |
| (7.1) | 9 | 9 | 8 | 8 |
| (5.1) | | | 9 | 9 |
| (5.2) | 9 | 9 | | |
| Tₙᵢ (° C.) | 79.1 | 80.2 | 79.0 | 79.4 |
| Δn | 0.104 | 0.107 | 0.108 | 0.105 |
| Δε | −2.61 | −2.67 | −2.64 | −2.71 |
| η/mPa · s | 19.6 | 20.4 | 20.2 | 20.1 |
| γ₁/mPa · s | 144 | 151 | 151 | 148 |

TABLE 18

| | Exam- | Exam- | Exam- | Exam- |
|---|---|---|---|---|
| | ple 27 | ple 28 | ple 29 | ple 30 |
| Initial voltage retention (%) | 99.7 | 99.1 | 99.5 | 99.2 |
| Voltage retention at 150° C. | 99.0 | 98.1 | 98.2 | 98.3 |
| after 1 hour (%) | | | | |
| Evaluation of burn-in | ⊙ | ⊙ | ⊙ | ◯ |
| Evaluation of dropping marks | ⊙ | ⊙ | ◯ | ◯ |
| Evaluation of process | ⊙ | ◯ | ⊙ | ⊙ |
| applicability | | | | |
| Evaluation of solubility at low | ⊙ | ⊙ | ◯ | ⊙ |
| temperature | | | | |

The liquid crystal compositions of Examples 27 to 30 have a practical liquid crystal phase temperature range of 79.0° C. to 80.2° C. as a liquid crystal composition for TV application, and the refractive index anisotropy and the dielectric anisotropy are also excellent. The liquid crystal compositions of Examples 27, 28, and 30 each showed a significantly excellent result of the evaluation of solubility at a low temperature.

The VA liquid crystal display elements of Example 27 showed significantly excellent results of the evaluations of burn-in, dropping marks, and process applicability. The VA liquid crystal display element of Example 28 showed significantly excellent results of the evaluations of burn-in and dropping marks. The VA liquid crystal display element of Example 29 showed significantly excellent results of the evaluations of burn-in and process applicability. The VA liquid crystal display element of Example 30 showed a significantly excellent result of the evaluation of process applicability.

The VA liquid crystal display elements of Examples 27 to 30 each showed excellent results of the initial voltage retention and the voltage retention at 150° C. after 1 hour.

### Examples 31 to 34

Liquid crystal compositions having compositions shown in Table 19 were prepared, and the physical properties thereof were measured.

In addition, by the use of each of the liquid crystal compositions of Examples 31 to 34, a display element was formed in a manner similar to that of Example 1, and the evaluations of burn-in, dropping marks, process applicability, and solubility at a low temperature were performed on the display element thus obtained. The results are shown in Table 20.

TABLE 19

Rate (%)

| Chemical | Exam- | Exam- | Exam- | Exam- |
|---|---|---|---|---|
| formula | ple 31 | ple 32 | ple 33 | ple 34 |
| (b2) | 4 | 4 | 3 | 4 |
| (8.3) | 2 | | | 2 |
| (8.5) | | 2 | 2 | |
| (8.1) | 23 | 24 | 22 | 26 |
| (1) | 3 | 2 | 4 | |
| (3.1) | 11 | 11 | 11 | 11 |
| (3.2) | 11 | 11 | 11 | 11 |
| (7.1) | 6 | 6 | 6 | 6 |
| (5.2) | | 12 | 12 | |
| (5.1) | 11 | | | 11 |
| (4.1) | 8 | 8 | 8 | 8 |
| (9.1) | 7 | 7 | 8 | 7 |
| (2.1) | 13 | 13 | 13 | 6 |
| (2.2) | | | | 7 |
| Tₙᵢ (° C.) | 77.4 | 78.3 | 79.1 | 75.6 |
| Δn | 0.104 | 0.104 | 0.105 | 0.103 |
| Δε | −3.59 | −3.57 | −3.76 | −3.51 |
| η/mPa · s | 22.0 | 22.7 | 23.9 | 22.0 |
| γ₁/mPa · s | 134 | 141 | 151 | 139 |

TABLE 20

| | Exam- | Exam- | Exam- | Exam- |
|---|---|---|---|---|
| | ple 31 | ple 32 | ple 33 | ple 34 |
| Initial voltage retention (%) | 99.2 | 99.1 | 99.1 | 99.4 |
| Voltage retention at 150° C. | 98.2 | 98.3 | 98.1 | 98.4 |
| after 1 hour (%) | | | | |
| Evaluation of burn-in | ◯ | ⊙ | ⊙ | ⊙ |
| Evaluation of dropping marks | ⊙ | ◯ | ⊙ | ⊙ |
| Evaluation of process | ⊙ | ◯ | ◯ | ◯ |
| applicability | | | | |
| Evaluation of solubility at low | ⊙ | ◯ | ⊙ | ⊙ |
| temperature | | | | |

The liquid crystal compositions of Examples 31 to 34 have a practical liquid crystal phase temperature range of 75.6° C. to 79.1° C. as a liquid crystal composition for TV application, and the refractive index anisotropy and the dielectric anisotropy are also excellent. The liquid crystal compositions of Examples 31, 33, and 34 showed a significantly excellent result of the evaluation of solubility at a low temperature.

The VA liquid crystal display elements of Example 31 showed significantly excellent results of the evaluations of dropping marks and process applicability. The VA liquid crystal display element of Example 32 showed a significantly excellent result of the evaluation of burn-in. The VA liquid crystal display element of Example 33 showed significantly excellent results of the evaluations of burn-in and dropping marks. The VA liquid crystal display element of Example 34 showed significantly excellent results of the evaluations of burn-in and dropping marks.

The VA liquid crystal display elements of Examples 31 to 34 each showed excellent results of the initial voltage retention and the voltage retention at 150° C. after 1 hour.

### Examples 35 to 40

Liquid crystal compositions having compositions shown in Table 21 were prepared, and the physical properties thereof were measured.

In addition, by the use of each of the liquid crystal compositions of Examples 35 to 40, a display element was formed in a manner similar to that of Example 1, and the evaluations of burn-in, dropping marks, process applicability, and solubility at a low temperature were performed on the display element thus obtained. The results are shown in Table 22.

TABLE 21

| | Rate (%) | | | | | |
|---|---|---|---|---|---|---|
| Chemical | Exam- | Exam- | Exam- | Exam- | Exam- | Exam- |
| formula | ple 35 | ple 36 | ple 37 | ple 38 | ple 39 | ple 40 |
| (1) | 11 | 10 | 9 | 12 | 13 | 8 |
| (8.2) | 9 | 10 | 11 | 8 | 7 | 12 |
| (8.3) | 6 | 6 | 6 | 5 | 7 | 6 |
| (8.5) | 9 | 9 | 9 | 9 | 8 | 10 |
| (6.1) | 9 | 9 | 9 | 10 | 9 | 8 |
| (3.1) | 4 | 3 | 4 | 4 | 4 | 4 |
| (3.2) | 9 | 10 | 9 | 9 | 9 | 9 |
| (2.1) | 13 | 13 | 14 | 13 | 13 | 13 |
| (9.1) | 4 | 4 | 3 | 4 | 4 | 4 |
| (4.2) | 6 | 6 | 6 | 6 | 6 | 6 |
| (7.1) | 9 | 9 | 9 | 9 | 9 | 9 |
| (5.1) | 11 | 11 | 11 | 11 | 11 | 11 |
| Tₙᵢ (° C.) | 75.0 | 75.3 | 75.0 | 74.8 | 74.6 | 75.4 |
| Δn | 0.095 | 0.095 | 0.095 | 0.095 | 0.095 | 0.095 |
| Δε | −2.95 | −2.94 | −2.93 | −2.95 | −2.97 | −2.92 |
| η/mPa · s | 24.7 | 24.8 | 24.9 | 24.6 | 24.4 | 25.2 |
| γ₁/mPa · s | 157 | 158 | 158 | 157 | 156 | 159 |

TABLE 22

| | Exam- | Exam- | Exam- | Exam- | Exam- | Exam- |
|---|---|---|---|---|---|---|
| | ple 35 | ple 36 | ple 37 | ple 38 | ple 39 | ple 40 |
| Initial voltage | 99.1 | 99.1 | 99.2 | 99.4 | 99.1 | 99.2 |
| retention (%) | | | | | | |
| Voltage retention at | 98.1 | 98.3 | 98.2 | 98.4 | 98.3 | 98.2 |
| 150° C. after 1 hour (%) | | | | | | |
| Evaluation of burn-in | ⊙ | ⊙ | ◯ | ⊙ | ⊙ | ◯ |
| Evaluation of dropping | ⊙ | ◯ | ⊙ | ⊙ | ◯ | ⊙ |
| marks | | | | | | |
| Evaluation of process | ⊙ | ◯ | ◯ | ◯ | ◯ | ◯ |
| applicability | | | | | | |
| Evaluation of solubility | ⊙ | ◯ | ⊙ | ⊙ | ◯ | ⊙ |
| at low temperature | | | | | | |

The liquid crystal compositions of Examples 35 to 40 have a practical liquid crystal phase temperature range of 74.6° C. to 75.4° C. as a liquid crystal composition for TV application, and the refractive index anisotropy and the dielectric anisotropy are also excellent. The liquid crystal compositions of Examples 35, 37, 38, and 40 each showed a significantly excellent result of the evaluation of solubility at a low temperature.

The VA liquid crystal display elements of Example 35 showed significantly excellent results of the evaluations of burn-in, dropping marks, and process applicability. The VA liquid crystal display element of Example 36 showed a significantly excellent result of the evaluation of burn-in. The VA liquid crystal display element of Example 37 showed a significantly excellent result of the evaluation of dropping marks. The VA liquid crystal display element of Example 38 showed significantly excellent results of the evaluations of burn-in and dropping marks. The VA liquid crystal display element of Example 39 showed a significantly excellent result of the evaluation of burn-in. The VA liquid crystal display element of Example 40 showed a significantly excellent result of the evaluation of dropping marks.

The VA liquid crystal display elements of Examples 35 to 40 each showed excellent results of the initial voltage retention and the voltage retention at 150° C. after 1 hour.

### Examples 41 to 44

Liquid crystal compositions having compositions shown in Table 23 were prepared, and the physical properties thereof were measured.

In addition, by the use of each of the liquid crystal compositions of Examples 41 to 44, a display element was formed in a manner similar to that of Example 1, and the evaluations of burn-in, dropping marks, process applicability, and solubility at a low temperature were performed on the display element thus obtained. The results are shown in Table 24.

TABLE 23

Rate (%)

| Chemical | Exam- | Exam- | Exam- | Exam- |
|---|---|---|---|---|
| formula | ple 41 | ple 42 | ple 43 | ple 44 |
| (1) | 15 | 15 | 15 | 15 |
| (8.2) | 6 | 4 | 6 | |
| (8.5) | 6 | 6 | 6 | 6 |
| (b1) | 5 | 5 | 5 | 5 |
| (6.1) | | | | 6 |
| (a4) | 2 | 2 | 2 | 2 |
| (4.1) | 12 | 12 | 12 | 12 |
| (2.2) | 21 | 23 | 18 | 21 |
| (5.1) | 6 | 6 | 6 | 6 |
| (5.2) | 3 | 3 | 3 | 3 |
| (10.1) | 11 | 11 | 14 | 11 |
| (10.2) | 11 | 11 | 11 | 11 |
| (4.2) | 3 | 3 | 3 | 3 |
| Tₙᵢ (° C.) | 76.7 | 75.2 | 80.7 | 72.4 |
| Δn | 0.096 | 0.097 | 0.096 | 0.097 |
| Δε | −2.70 | −2.84 | −2.59 | −2.70 |
| η/mPa · s | 26.0 | 26.4 | 27.0 | 25.8 |
| γ₁/mPa · s | 166 | 168 | 175 | 168 |

TABLE 24

| | Exam- | Exam- | Exam- | Exam- |
|---|---|---|---|---|
| | ple 41 | ple 42 | ple 43 | ple 44 |
| Initial voltage retention (%) | 99.1 | 99.2 | 99.4 | 99.1 |
| Voltage retention at 150° C. | 98.3 | 98.2 | 98.4 | 98.3 |
| after 1 hour (%) | | | | |
| Evaluation of burn-in | ⊙ | ◯ | ⊙ | ⊙ |
| Evaluation of dropping marks | ⊙ | ⊙ | ⊙ | ◯ |
| Evaluation of process | ⊙ | ◯ | ◯ | ◯ |
| applicability | | | | |
| Evaluation of solubility at low | ⊙ | ⊙ | ⊙ | ◯ |
| temperature | | | | |

The liquid crystal compositions of Examples 41 to 44 have a practical liquid crystal phase temperature range of 72.4° C. to 80.7° C. as a liquid crystal composition for TV application, and the refractive index anisotropy and the dielectric anisotropy are also excellent. The liquid crystal compositions of Examples 41 to 43 each showed a significantly excellent result of the evaluation of solubility at a low temperature.

The VA liquid crystal display elements of Example 41 showed significantly excellent results of the evaluations of burn-in, dropping marks, and process applicability. The VA liquid crystal display element of Example 42 showed a significantly excellent result of the evaluation of dropping marks. The VA liquid crystal display element of Example 43 showed significantly excellent results of the evaluations of burn-in and dropping marks. The VA liquid crystal display element of Example 44 showed a significantly excellent result of the evaluation of burn-in.

The VA liquid crystal display elements of Examples 41 to 44 each showed excellent results of the initial voltage retention and the voltage retention at 150° C. after 1 hour.

### Examples 45 to 50

Liquid crystal compositions having compositions shown in Table 25 were prepared, and the physical properties thereof were measured.

In addition, by the use of each of the liquid crystal compositions of Examples 45 to 50, a display element was formed in a manner similar to that of Example 1, and the evaluations of burn-in, dropping marks, process applicability, and solubility at a low temperature were performed on the display element thus obtained. The results are shown in Table 26.

TABLE 25

| | Rate (%) | | | | | |
|---|---|---|---|---|---|---|
| Chemical | Exam- | Exam- | Exam- | Exam- | Exam- | Exam- |
| formula | ple 45 | ple 46 | ple 47 | ple 48 | ple 49 | ple 50 |
| (1) | 7 | 7 | 7 | 7 | 6 | 7 |
| (8.2) | 6 | 6 | 6 | 6 | 6 | 6 |
| (b1) | 21 | 21 | 21 | 21 | 22 | 12 |
| (8.3) | | | | | | 8 |
| (a4) | 3 | 3 | 3 | 3 | 3 | 3 |
| (3.1) | 19 | 15 | 20 | 20 | 19 | 19 |
| (3.2) | 6 | 6 | 6 | 6 | 6 | 6 |
| (7.1) | 4 | 4 | 4 | 4 | 4 | 4 |
| (5.2) | 14 | 14 | 13 | 13 | 14 | 15 |
| (2.2) | 17 | 20 | 17 | 17 | 17 | 17 |
| (9.2) | 5 | 5 | 5 | 4 | 5 | 5 |
| Tₙᵢ (° C.) | 83.0 | 78.1 | 82.7 | 83.3 | 82.4 | 82.7 |
| Δn | 0.097 | 0.094 | 0.098 | 0.098 | 0.097 | 0.097 |
| Δε | −3.99 | −4.00 | −4.00 | −3.92 | −3.99 | −4.06 |
| η/mPa · s | 36.3 | 34.4 | 36.4 | 36.1 | 36.7 | 35.7 |
| γ₁/mPa · s | 238 | 222 | 238 | 236 | 239 | 236 |

TABLE 26

| | Exam- | Exam- | Exam- | Exam- | Exam- | Exam- |
|---|---|---|---|---|---|---|
| | ple 45 | ple 46 | ple 47 | ple 48 | ple 49 | ple 50 |
| Initial voltage | 99.3 | 99.0 | 99.5 | 99.4 | 99.2 | 99.4 |
| retention (%) | | | | | | |
| Voltage retention at | 98.3 | 98.4 | 98.2 | 98.0 | 98.2 | 98.4 |
| 150° C. after 1 hour (%) | | | | | | |
| Evaluation of burn-in | ⊙ | ⊙ | ◯ | ⊙ | ◯ | ⊙ |
| Evaluation of dropping | ⊙ | ◯ | ◯ | ⊙ | ⊙ | ⊙ |
| marks | | | | | | |
| Evaluation of process | ⊙ | ⊙ | ◯ | ◯ | ◯ | ◯ |
| applicability | | | | | | |
| Evaluation of solubility | ⊙ | ⊙ | ⊙ | ◯ | ⊙ | ⊙ |
| at low temperature | | | | | | |

The liquid crystal compositions of Examples 45 to 50 have a practical liquid crystal phase temperature range of 78.1° C. to 83.3° C. as a liquid crystal composition for TV application, and the refractive index anisotropy and the dielectric anisotropy are also excellent. The liquid crystal compositions of Examples 45 to 47, 49, and 50 each showed a significantly excellent result of the evaluation of solubility at a low temperature.

The VA liquid crystal display elements of Example 45 showed significantly excellent results of the evaluations of burn-in, dropping marks, and process applicability. The VA liquid crystal display element of Example 46 showed significantly excellent results of the evaluations of burn-in and process applicability. The VA liquid crystal display element of Example 48 showed significantly excellent results of the evaluations of burn-in and dropping marks. The VA liquid crystal display element of Example 49 showed a significantly excellent result of the evaluation of dropping marks. The VA liquid crystal display element of Example 50 showed significantly excellent results of the evaluations of burn-in and dropping marks.

The VA liquid crystal display elements of Examples 45 to 50 each showed excellent results of the initial voltage retention and the voltage retention at 150° C. after 1 hour.

### Examples 51 to 53

Liquid crystal compositions having compositions shown in Table 27 were prepared, and the physical properties thereof were measured.

In addition, by the use of each of the liquid crystal compositions of Examples 51 to 53, a display element was formed in a manner similar to that of Example 1, and the evaluations of the burn-in, dropping marks, process applicability, and solubility at a low temperature were performed on the display element thus obtained. The results are shown in Table 28.

TABLE 27

| | Rate (%) | | |
|---|---|---|---|
| Chemical | Exam- | Exam- | Exam- |
| formula | ple 51 | ple 52 | ple 53 |
| (2.1) | 13 | 13 | 8 |
| (2.2) | | | 5 |
| (6.2) | 8 | 8 | 7 |
| (8.1) | 23 | 22 | 22 |
| (1) | 11 | 11 | 11 |
| (3.1) | 5 | 5 | 5 |
| (3.2) | 10 | 10 | 10 |
| (4.1) | 13 | 14 | 15 |
| (7.1) | 9 | 9 | 8 |
| (5.1) | | | 9 |
| (5.2) | 9 | 9 | |
| Tₙᵢ (° C.) | 80.0 | 81.0 | 80.0 |
| Δn | 0.104 | 0.107 | 0.108 |
| Δε | −2.6 | −2.7 | −2.6 |
| η/mPa · s | 22.0 | 22.7 | 23.9 |
| γ₁/mPa · s | 134 | 141 | 151 |

TABLE 28

| | Exam- | Exam- | Exam- |
|---|---|---|---|
| | ple 51 | ple 52 | ple 53 |
| Initial voltage retention (%) | 99.2 | 99.1 | 99.1 |
| Voltage retention at 150° C. | 98.2 | 98.3 | 98.1 |
| after 1 hour (%) | | | |
| Evaluation of burn-in | ◯ | ⊙ | ⊙ |
| Evaluation of dropping marks | ⊙ | ◯ | ⊙ |
| Evaluation of process | ⊙ | ◯ | ◯ |
| applicability | | | |
| Evaluation of solubility at low | ⊙ | ◯ | ⊙ |
| temperature | | | |

The liquid crystal compositions of Examples 51 to 53 have a practical liquid crystal phase temperature range of 80.0° C. to 81.0° C. as a liquid crystal composition for TV application, and the refractive index anisotropy and the dielectric anisotropy are also excellent. The liquid crystal compositions of Examples 51 and 53 each showed a significantly excellent result of the evaluation of solubility at a low temperature.

The VA liquid crystal display elements of Example 51 showed significantly excellent results of the evaluations of dropping marks and process applicability. The VA liquid crystal display element of Example 52 showed a significantly excellent result of the evaluation of burn-in. The VA liquid crystal display element of Example 53 showed significantly excellent results of the evaluations of burn-in and dropping marks.

The VA liquid crystal display elements of Examples 51 to 53 each showed excellent results of the initial voltage retention and the voltage retention at 150° C. after 1 hour.

### Examples 54 to 57

Liquid crystal compositions having compositions shown in Table 29 were prepared, and the physical properties thereof were measured.

In addition, by the use of each of the liquid crystal compositions of Examples 54 to 57, a display element was formed in a manner similar to that of Example 1, and the evaluations of burn-in, dropping marks, process applicability, and solubility at a low temperature were performed on the display element thus obtained. The results are shown in Table 30.

TABLE 29

Rate (%)

| Chemical | Exam- | Exam- | Exam- | Exam- |
|---|---|---|---|---|
| formula | ple 54 | ple 55 | ple 56 | ple 57 |
| (5.1) | 10 | 9 | 10 | 7 |
| (5.2) | | | | 3 |
| (2.1) | 15 | 15 | 15 | 15 |
| (8.4) | 2 | 3 | 4 | 6 |
| (8.1) | 23 | 24 | 21 | 19 |
| (1) | 13 | 11 | 13 | 14 |
| (3.1) | 12 | 12 | 12 | 12 |
| (3.2) | 12 | 12 | 12 | 12 |
| (4.1) | 9 | 10 | 6 | 9 |
| (4.2) | | | 3 | |
| (c1) | 4 | 4 | 4 | 3 |
| Tₙᵢ (° C.) | 77.4 | 78.3 | 79.1 | 75.6 |
| Δn | 0.102 | 0.104 | 0.102 | 0.103 |
| Δε | −2.60 | −2.54 | −2.62 | −2.71 |
| η/mPa · s | 20.3 | 22.3 | 22.5 | 20.5 |
| γ₁/mPa · s | 121 | 120 | 134 | 127 |

TABLE 30

| | Exam- | Exam- | Exam- | Exam- |
|---|---|---|---|---|
| | ple 54 | ple 55 | ple 56 | ple 57 |
| Initial voltage retention (%) | 99.1 | 99.1 | 99.2 | 99.4 |
| Voltage retention at 150° C. | 98.1 | 98.3 | 98.2 | 98.4 |
| after 1 hour (%) | | | | |
| Evaluation of burn-in | ⊙ | ⊙ | ◯ | ⊙ |
| Evaluation of dropping marks | ⊙ | ◯ | ⊙ | ⊙ |
| Evaluation of process | ⊙ | ◯ | ◯ | ◯ |
| applicability | | | | |
| Evaluation of solubility at low | ⊙ | ◯ | ⊙ | ⊙ |
| temperature | | | | |

The liquid crystal compositions of Examples 54 to 57 have a practical liquid crystal phase temperature range of 75.6° C. to 79.1° C. as a liquid crystal composition for TV application, and the refractive index anisotropy and the dielectric anisotropy are also excellent. The liquid crystal compositions of Examples 54, 56, and 57 each showed a significantly excellent result of the evaluation of solubility at a low temperature.

The VA liquid crystal display elements of Example 54 showed significantly excellent results of the evaluations of burn-in, dropping marks, and process applicability. The VA liquid crystal display element of Example 55 showed a significantly excellent result of the evaluation of burn-in. The VA liquid crystal display element of Example 56 showed a significantly excellent result of the evaluation of dropping marks. The VA liquid crystal display element of Example 57 showed significantly excellent results of the evaluations of burn-in and dropping marks.

The VA liquid crystal display elements of Examples 54 to 57 each showed excellent results of the initial voltage retention and the voltage retention at 150° C. after 1 hour.

The structures described in the embodiments, the combination therebetween, and the like have been described by way of example, and changes and modifications thereof, such as addition, omission, and replacement, may be performed without departing from the scope of the present invention. In addition, the present invention is not limited to the above embodiments and is to be limited only by claims.

### INDUSTRIAL APPLICABILITY

The liquid crystal composition according to the present invention may be widely applied to fields of liquid crystal display elements and liquid crystal displays.

### REFERENCE SIGNS LIST

1 polarizer, 2 substrate, 3 transparent electrode or transparent electrode with active element, 4 alignment film, liquid crystal, 11 gate electrode, 12 anodic oxidation coating, 13 gate insulating layer, 14 transparent electrode, drain electrode, 16 ohmic contact layer, 17 semiconductor layer, 18 protective film, 19a source electrode 1, 19b source electrode 2, 100 substrate, 101 protective layer

1. A liquid crystal composition having a negative dielectric anisotropy, the composition comprising: a component (B) which contains a dielectrically neutral compound represented by the following formula (1) and which is a dielectrically neutral component having a dielectric anisotropy of more than −2 to less than +2; and a dielectrically negative component (A) which contains at least two types of compounds selected from the group consisting of compounds represented by the following formulas (2) to (5) 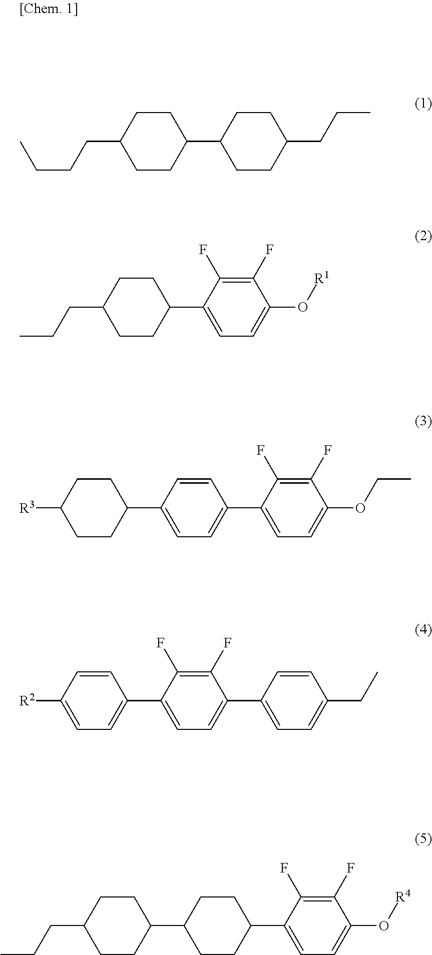
(in the formulas, R¹ and R⁴ each independently represent an alkyl group having 1 to 8 carbon atoms, R² and R³ each independently represent an alkyl group having 1 to 8 carbon atoms or an alkenyl group having 2 to 8 carbon atoms, and at least one methylene group of the alkyl group or the alkenyl group of each of R² and R³ may be substituted by an oxygen atom as long as oxygen atoms are not continuously bonded to each other or by a carbonyl group as long as carbonyl groups are not continuously bonded to each other).

2. The liquid crystal composition according to claim 1, wherein the component (A) contains at least two types of compounds selected from the group consisting of compounds represented by the following formulas (2.1), (2.2), (3.1), (3.2), (4.1), (4.2), (5.1), and (5.2)

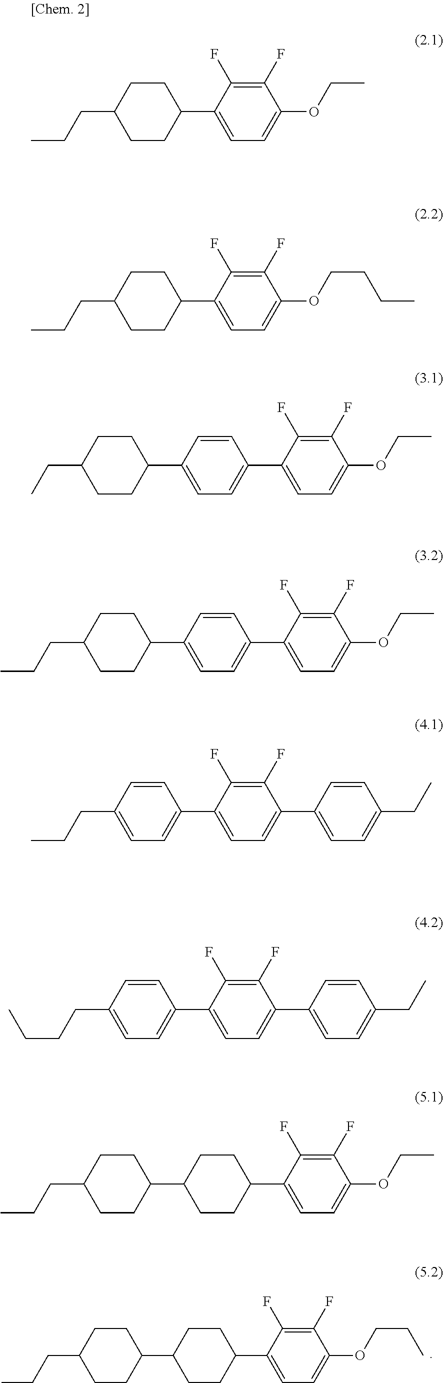

3. The liquid crystal composition according to claim 1, wherein the component (B) contains a compound represented by the following formula (6.1) or (6.2)

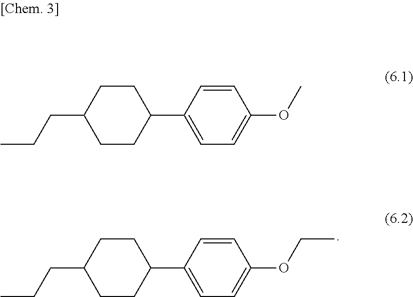

4. The liquid crystal composition according to claim 1, wherein the component (A) contains a compound represented by the following formula (7.1) or (7.2)

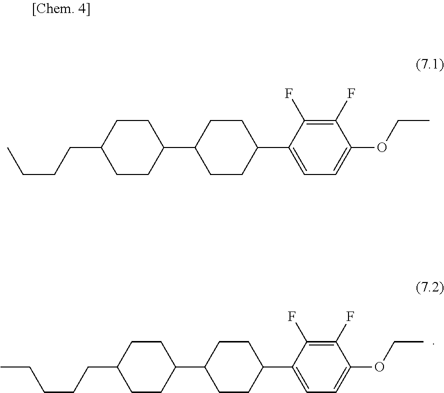

5. The liquid crystal composition according to claim 1, wherein the component (B) contains a compound represented by the following formula (8) 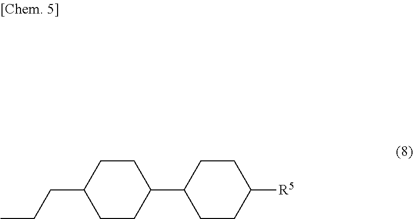
(in the formula, R⁵ represents an alkyl group having 2 or 5 carbon atoms or an alkoxy group having 1 to 3 carbon atoms).

6. The liquid crystal composition according to claim 1, wherein the component (A) contains a compound represented by the following formula (9.1) or (9.2)

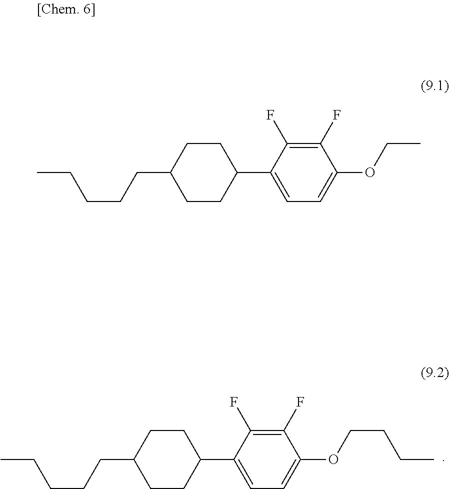

7. The liquid crystal composition according to claim 1, wherein the component (A) contains a compound represented by the following formula (10.1) or (10.2)

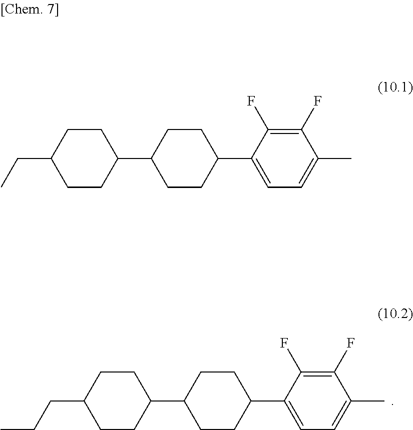

8. A liquid crystal display element using the liquid crystal composition according to claim 1.

9. A liquid crystal display using the liquid crystal display element according to claim 8.
